(19) United States
(12) Patent Application Publication
(10) Pub. No.: US 2026/0142571 A1
(43) Pub. Date: May 21, 2026

(54) POWER SUPPLY DEVICE

(71) Applicant: ROHM CO., LTD., Kyoto (JP)

(72) Inventor: Takatsugu WACHI, Kyoto (JP)

(21) Appl. No.: 19/446,635

(22) Filed: Jan. 12, 2026

Related U.S. Application Data
(63) Continuation of application No. PCT/JP2024/019747, filed on May 29, 2024.

(30) Foreign Application Priority Data
Jul. 19, 2023 (JP) 2023-117305

(51) Int. Cl. H02M 3/158; H02M 1/00; H02M 1/088

(52) U.S. Cl. CPC H02M 3/158; H02M 1/0095; H02M 1/088

(57) ABSTRACT

First to fourth switching elements are connected in series from a reference node to a power supply node applied with an input voltage. Each switching element is constituted of an N-channel type MOSFET. In order to turn on the second to the fourth switching elements, first to third boot voltages supplied to the gates of the second to fourth switching elements are generated in first to third boot wirings. The boot voltages are generated using first to third boot capacitors and first to third boot switches, which are disposed corresponding to the first to third boot wirings.

### DESCRIPTION

### CROSS-REFERENCE TO RELATED APPLICATIONS

This nonprovisional application is a continuation application of International Patent Application No. PCT/JP2024/019747 filed on May 29, 2024, which claims priority to Japanese Patent Application No. 2023-117305 filed on July 19, 2023, the entire contents of which are hereby incorporated by reference.

### TECHNICAL FIELD

The present disclosure relates to a power supply device.

### BACKGROUND ART

A power supply device, which steps down an input voltage using a plurality of switching elements so as to generate a desired output voltage, is widely used.

### List of Citations

### Patent Literature

Patent Document 1: JP-A-2020-89043

### BRIEF DESCRIPTION OF DRAWINGS

FIG. 1 is an overall configuration diagram of a power supply device according to a first embodiment of the present disclosure.

FIG. 2 is a diagram illustrating a relationship among control signals, gate signals, and state of switching elements, according to the first embodiment of the present disclosure.

FIG. 3 is a diagram for explaining current flows when switching control is performed in the power supply device according to the first embodiment of the present disclosure.

FIG. 4 is a configuration diagram of the power supply device illustrating an internal configuration of a control circuit, according to the first embodiment of the present disclosure.

FIG. 5 is a timing chart of the power supply device, according to the first embodiment of the present disclosure.

FIG. 6 is a diagram illustrating an internal configuration of the driving circuit, according to the first embodiment of the present disclosure.

FIG. 7 is a diagram illustrating an internal configuration of a step-up circuit, according to the first embodiment of the present disclosure.

FIG. 8 is a diagram illustrating an internal configuration of the driving circuit and the step-up circuit, according to the first embodiment of the present disclosure.

FIG. 9 is a diagram illustrating conditions of the switching elements and boot switches in a state ST_A1, according to the first embodiment of the present disclosure.

FIG. 10 is a diagram illustrating conditions of the switching elements and the boot switches in a state ST_A2, according to the first embodiment of the present disclosure.

FIG. 11 is an external perspective view of a power supply control device according to the first embodiment of the present disclosure.

FIG. 12 is a diagram illustrating a relationship between the power supply control device and a group of discrete components, according to the first embodiment of the present disclosure.

FIG. 13 is an overall configuration diagram of the power supply device according to a second embodiment of the present disclosure.

FIG. 14 is a diagram illustrating states of the switching elements and generated currents in a state ST_B1, according to the second embodiment of the present disclosure.

FIG. 15 is a diagram illustrating states of the switching elements and generated currents in a state ST_B2, according to the second embodiment of the present disclosure.

FIG. 16 is a diagram illustrating states of the switching elements and generated currents in a state ST_B3, according to the second embodiment of the present disclosure.

FIG. 17 is a diagram illustrating states of the switching elements and generated currents in a state ST_B4, according to the second embodiment of the present disclosure.

FIG. 18 is an overall configuration diagram of the power supply device according to a third embodiment of the present disclosure.

FIG. 19 is a diagram illustrating states of the switching elements and generated currents in a state ST_C1, according to the third embodiment of the present disclosure.

FIG. 20 is a diagram illustrating states of the switching elements and generated currents in a state ST_C2, according to the third embodiment of the present disclosure.

FIG. 21 is a diagram illustrating states of the switching elements and generated currents in a state ST_C3, according to the third embodiment of the present disclosure.

FIG. 22 is a diagram illustrating states of the switching elements and generated currents in a state ST_C4, according to the third embodiment of the present disclosure.

FIG. 23 is an internal configuration diagram of the control circuit, according to the third embodiment of the present disclosure.

FIG. 24 is a timing chart of the power supply device, according to the third embodiment of the present disclosure.

FIG. 25 is a diagram illustrating a variation of the power supply device according to the third embodiment of the present disclosure.

### DESCRIPTION OF EMBODIMENTS

Hereinafter, an example of an embodiment of the present disclosure is specifically described with reference to the drawings. In the drawings to be referred to, the same part is denoted by the same numeral or symbol, and overlapping description of the same part is omitted as a rule. Note that in this specification, for simple description, by referring to a symbol or sign indicating information, a signal, a physical quantity, a functional unit, a circuit, an element, a component, or the like, a name of the information, the signal, the physical quantity, the functional unit, the circuit, the element, the component, or the like corresponding to the symbol or sign may be omitted or shortened.

First, some definitions of terms used for describing the embodiment of the present disclosure are given below. A ground means a reference conductive part having a reference potential of 0 V (zero volts) or means the reference potential of 0 V itself. If a certain component, electrode, or node is connected to the ground, it means that the component, electrode, or node is connected to a reference node having the reference potential of 0 V. The reference node and the ground can be read as each other.

A level means a potential level (electric potential level), and a high level has a higher potential than a low level for any given signal or voltage. For any given signal or voltage, if the signal or voltage is at high level, it strictly means that a level of the signal or voltage is at high level, and if the signal or voltage is at low level, it strictly means that a level of the signal or voltage is at low level. For any given signal or voltage, switching from low level to high level is referred to as a rising edge, while switching from high level to low level is referred to as a falling edge.

Any switching element can be constituted of a transistor. For any transistor constituting an FET (field-effect transistor) including MOSFET, ON state means a state where the transistor is conductive between the drain and the source, while OFF state means a state where the transistor is non-conductive between the drain and the source (a cut-off state). The same is true for a transistor that is not classified as an FET. A MOSFET is understood to be an enhancement type MOSFET unless otherwise noted. MOSFET is an abbreviation of "metal-oxide-semiconductor field-effect transistor". In addition, in any MOSFET, it can be understood that the backgate is short-circuited to the source unless otherwise noted.

Hereinafter, for any switching element (transistor), ON state and OFF state may be simply expressed as ON and OFF. For any switching element, switching from OFF state to ON state is expressed as turning on, and switching from ON state to OFF state is expressed as turning off. In addition, for any switching element, a period during which a switching element is in ON state is referred to as ON period, while a period during which a switching element is in OFF state is referred to as OFF period.

For any signal having a signal level of high level or low level, a period during which the signal level is high level is referred to as a high level period, while a period during which the signal level is low level is referred to as a low level period. The same is true for any voltage having a voltage level of high level or low level.

Connection between any parts forming a circuit, such as circuit elements, wirings, and nodes can be understood to mean electric connection unless otherwise noted.

Supposing that any two voltages to be compared are voltages v1 and v2, "v1 > v2" means that the voltage v1 is higher than the voltage v2, while "v1 < v2" means that the voltage v1 is lower than the voltage v2. The same is true for other expression including a physical quantity other than a voltage.

### First Embodiment

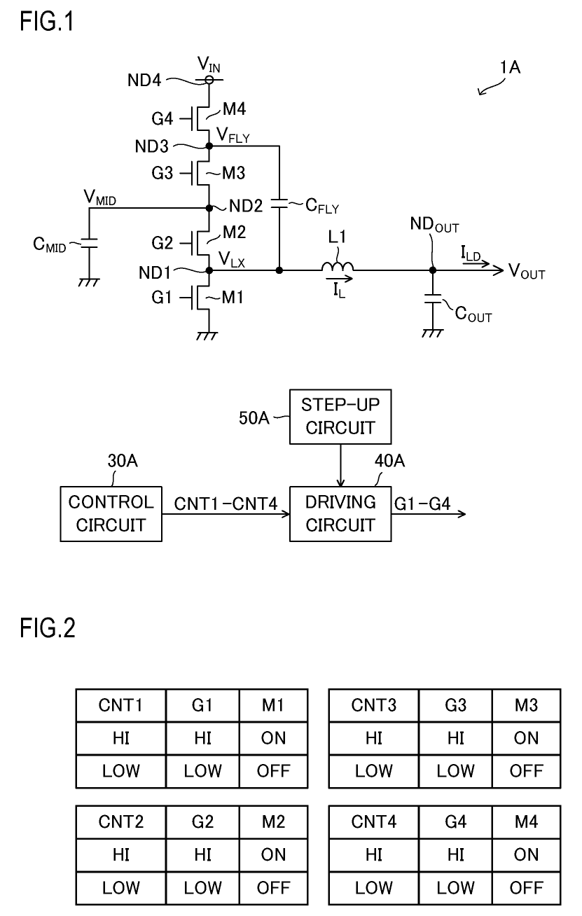

A first embodiment of the present disclosure is described below. FIG. 1 is an overall configuration diagram of a power supply device 1A according to the first embodiment of the present disclosure. The power supply device 1A receives supply of a positive input voltage V_{IN} from a not shown voltage source, and steps down the input voltage V_{IN} so as to generate a positive output voltage V_{OUT}. The output voltage V_{OUT} is lower than the input voltage V_{IN}. The power supply device 1A stabilizes the output voltage V_{OUT} at a predetermined target voltage. In other words, in a steady state, the output voltage V_{OUT} is substantially equal to a target voltage. Hereinafter, the target voltage is denoted by "V_{TG}". In the power supply device 1A, an intermediate voltage V_{MID} is generated. The output voltage V_{OUT} is lower than the intermediate voltage V_{MID}. In addition, in the steady state, the intermediate voltage V_{MID} is substantially a half of the input voltage V_{IN}. Therefore, "V_{IN} > 2 × V_{OUT}" holds. As long as "V_{IN} > 2 × V_{OUT}" holds, values of the input voltage V_{IN} and the output voltage V_{OUT} are arbitrary. In other words, as long as "V_{IN} > 2 × V_{TG}" holds, values of the input voltage V_{IN} and a target voltage V_{TG} are arbitrary. For instance, the input voltage V_{IN} is 48 V, and the target voltage V_{TG} (i.e., the output voltage V_{OUT} in the steady state) is 12 V or 5 V.

Note that for the power supply device 1A, the steady state means a state where the output voltage V_{OUT} is stabilized at the target voltage V_{TG}, after the power supply device 1A is activated and the output voltage V_{OUT} is increased from 0 V to reach the target voltage V_{TG}. In the following description, unless otherwise noted, it is supposed that the power supply device 1A is in the steady state.

The power supply device 1A includes switching elements M1 to M4, capacitors C_{FLY}, C_{MID}, and C_{OUT}, an inductor L1, a control circuit 30A, a driving circuit 40A, and a step-up circuit 50A, as main components. The capacitor C_{FLY} can be referred to as a flying capacitor. The capacitor C_{MID} can be referred to as an intermediate capacitor. The capacitor C_{OUT} can be referred to as an output capacitor.

The power supply device 1A includes a buck converter and a stacked converter. The buck converter in the power supply device 1A includes the switching elements M1 and M2, and the inductor L1, so as to generate the output voltage V_{OUT} at an output node ND_{OUT} by stepping down the intermediate voltage V_{MID}. It may be understood that the capacitor C_{OUT} is also included in components of the buck converter. The switching elements M1 and M2 function as a low-side switching element and a high-side switching element of the buck converter. The stacked converter in the power supply device 1A includes the switching elements M3 and M4, and the capacitor C_{FLY}, so as to generate the intermediate voltage V_{MID} from the input voltage V_{IN}. The capacitor C_{MID} can also be understood to be included in components of the stacked converter.

In this embodiment, each of the switching elements M1 to M4 is constituted of an N-channel type MOSFET. For this reason, in the following description, the switching elements M1 to M4 may be referred to as transistors M1 to M4.

The transistors M1 to M4 are connected in series between the ground and a node ND4. The transistor M1 is disposed between the ground and the node ND1, the transistor M2 is disposed between the nodes ND1 and ND2, the transistor M3 is disposed between the nodes ND2 and ND3, and the transistor M4 is disposed between the nodes ND3 and ND4. More specifically, the source of the transistor M1 is connected to the ground. The drain of the transistor M1 and the source of the transistor M2 are connected to the node ND1. The drain of the transistor M2 and the source of the transistor M3 are connected to the node ND2. The drain of the transistor M3 and the source of the transistor M4 are connected to the node ND3. The drain of the transistor M4 is connected to the node ND4. The node ND4 is a power supply node that receives the input voltage V_{IN}. In other words, the input voltage V_{IN} is supplied to the node ND4. Signals supplied to the gates of the transistors M1 to M4 are referred to as gate signals G1 to G4, respectively.

The capacitor C_{FLY} is disposed between the nodes ND3 and ND1. In other words, a first terminal of the capacitor C_{FLY} is connected to the node ND3, and a second terminal of the capacitor C_{FLY} is connected to the node ND1.

The capacitor C_{MID} is disposed between the node ND2 and the ground. In other words, a first terminal of the capacitor C_{MID} is connected to the node ND2, and a second terminal of the capacitor C_{MID} is connected to the ground. The first terminal of the capacitor C_{MID} corresponds to a positive terminal of the capacitor C_{MID}. A voltage at the node ND2 is the intermediate voltage V_{MID}. In other words, the intermediate voltage V_{MID} is generated across both terminals of the capacitor C_{MID}. Note that a voltage at the node ND1 is referred to as a voltage V_{LX}, and a voltage at the node ND3 is referred to as a voltage V_{FLY}.

The inductor L1 is disposed between the node ND1 and the output node ND_{OUT}. In other words, a first terminal of the inductor L1 is connected to the node ND1, and a second terminal of the inductor L1 is connected to the output node ND_{OUT}.

The capacitor C_{OUT} is disposed between the output node ND_{OUT} and the ground. In other words, a first terminal of the capacitor C_{OUT} is connected to the output node ND_{OUT}, and a second terminal of the capacitor C_{OUT} is connected to the ground. The first terminal of the capacitor C_{OUT} corresponds to a positive terminal of the capacitor C_{OUT}. A voltage at the output node ND_{OUT} is the output voltage V_{OUT}. In other words, the output voltage V_{OUT} is generated across both terminals of the capacitor C_{OUT}.

The control circuit 30A generates and outputs control signals that designate states of the transistors M1 to M4 (ON or OFF states). The control signals generated by the control circuit 30A include control signals CNT1 to CNT4. The control signals CNT1 to CNT4 are binary signals. Any binary signal has low level or high level. The control circuit 30A can set levels of the control signals CNT1 to CNT4 individually to high level or low level. The driving circuit 40A are connected to the gates of the transistors M1 to M4, and supplies the gate signals G1 to G4 corresponding to the control signals CNT1 to CNT4 to the transistors M1 to M4, so as to individually set the states of the transistors M1 to M4 to ON or OFF. The step-up circuit 50A generates the voltage necessary to turn on the transistors M2 to M4, and supplies the generated voltage to the driving circuit 40A. Details of the step-up circuit 50A will be described later.

The control circuit 30A controls the states of the transistors M1 to M4 in cooperation with the driving circuit 40A and the step-up circuit 50A, and thus generates the desired output voltage V_{OUT} lower than the input voltage V_{IN} at the output node ND_{OUT}.

FIG. 2 illustrates relationship among the control signals CNT1 to CNT4, the gate signals G1 to G4, and the states of the transistors M1 to M4. The control signals CNT1, CNT2, CNT3, and CNT4 of high level are signals that respectively instruct to set states of the transistors M1, M2, M3, and M4to ON state. The control signals CNT1, CNT2, CNT3, and CNT4 of low level are signals that respectively instruct to set the states of the transistors M1, M2, M3, and M4 to OFF state. Therefore, during a high level period of the control signal CNT1, the gate signal G1 is also high level, and the transistor M1 is turned on. During a low level period of the control signal CNT1, the gate signal G1 is also low level, and the transistor M1 is turned off. Similarly, during a high level period of the control signal CNT2, the gate signal G2 is also high level, and the transistor M2 is turned on. During a low level period of the control signal CNT2, the gate signal G2 is also low level, and the transistor M2 is turned off. Similarly, during a high level period of the control signal CNT3, the gate signal G3 is also high level, and the transistor M3 is turned on. During a low level period of the control signal CNT3, the gate signal G3 is also low level, and the transistor M3 is turned off. Similarly, during a high level period of the control signal CNT4, the gate signal G4 is also high level, and the transistor M4 is turned on. During a low level period of the control signal CNT4, the gate signal G4 is also low level, and the transistor M4 is turned off.

The output node ND_{OUT} is connected to a not shown load. The load is any load that is driven on the basis of the output voltage V_{OUT}. A current supplied from the output node ND_{OUT} to the load is referred to as a load current I_{LD}. The load current I_{LD} corresponds to an output current of the power supply device 1A. In addition, a current that flows through the inductor L1 is referred to as an inductor current I_{L}. It is supposed that the inductor current I_{L} from the node ND1 to the output node ND_{OUT} has a positive polarity, and that the inductor current I_{L} from the output node ND_{OUT} to the node ND1 has a negative polarity.

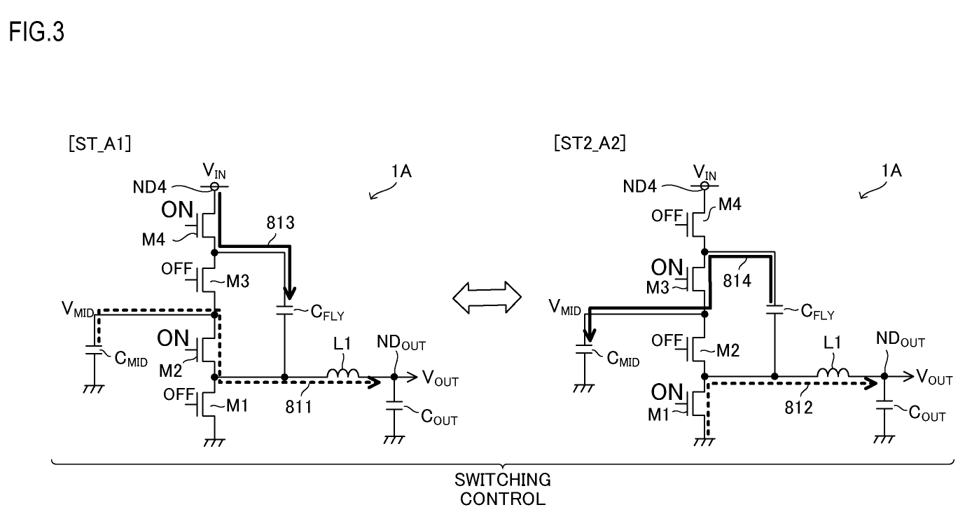

The control circuit 30A can set the states of the transistors M1 to M4 to any one of a plurality of states, and can switch among the plurality of states, using the driving circuit 40A. The plurality of states include states ST_A1 and ST_A2 illustrated in FIG. 3. In the state ST_A1, the transistors M2 and M4 are ON state, and the transistors M1 and M3 are OFF state. In the state ST_A2, the transistors M2 and M4 are OFF state, and the transistors M1 and M3 are ON state. A state where all the transistors M1 to M4 are OFF may be included in the plurality of states described above, but in this embodiment, the situation where all the transistors M1 to M4 are OFF is ignored in the following description.

The control circuit 30A can perform a switching control using the driving circuit 40A, so as to alternately switch the states of the transistors M1 to M4 between the states ST_A1 and ST_A2. With reference to FIG. 3, a current generated when the switching control is performed is described below. Note that with respect to a potential at the second terminal of the capacitor C_{FLY} (i.e., a potential at the node ND1), a current in the direction of increasing a potential at the first terminal of the capacitor C_{FLY} (i.e., a potential at the node ND3) is a charging current for the capacitor C_{FLY}, and a current in the opposite direction thereof is a discharge current for the capacitor C_{FLY}. For the capacitor C_{MID}, a current in the direction of increasing the intermediate voltage V_{MID} is a charging current, and a current in the direction of decreasing the intermediate voltage V_{MID} is a discharge current.

In the state ST_A1, currents 811 and 813 are generated. The current 811 is a current from the capacitor C_{MID} to the output node ND_{OUT} through the transistor M2 and the inductor L1 and is generated by discharging of the capacitor C_{MID}. The current 813 is a current from the node ND4 as an application terminal of the input voltage V_{IN} to the capacitor C_{FLY} through the transistor M4, and the capacitor C_{FLY} is charged by the current 813.

In the state ST_A2, currents 812 and 814 are generated. The current 812 flows from the ground to the output node ND_{OUT} through the transistor M1 and the inductor L1. The current 814 is a current from the capacitor C_{FLY} to the positive terminal of the capacitor C_{MID} through the transistor M3. The current 814 is generated by discharging of the capacitor C_{FLY}, and contributes to charging of the capacitor C_{MID}.

In the state ST_A1, the transistors M2 and M4 are ON, and hence the state ST_A1 for the capacitors C_{FLY} and C_{MID} is equivalent to the state where the capacitors C_{FLY} and C_{MID} are connected in series. In addition, in the state ST_A2, the capacitors C_{FLY} and C_{MID} are connected in parallel through the switching elements M1 and M3. As a result, the transistors M1 to M4 and the capacitors C_{FLY} and C_{MID} form a switched capacitor circuit. For this reason, in the steady state, the intermediate voltage V_{MID} as a voltage at the positive terminal of the capacitor C_{MID} is substantially a voltage (V_{IN}/2). In other words, the intermediate voltage V_{MID} corresponding to a divided voltage of the input voltage V_{IN} is generated by the switching control. In this way, the control circuit 30A allows the circuit including the transistors M1 to M4 and the capacitors C_{MID} and C_{FLY} to work as the switched capacitor circuit in the switching control, and thus the intermediate voltage V_{MID} is generated at the node ND2.

On the other hand, a synchronous buck converter that steps down the intermediate voltage V_{MID} is formed of the transistors M1 and M2 and the inductor L1. For this reason, the power supply device 1A can be referred to as a hybrid buck converter in which the switched capacitor circuit and the synchronous buck converter are fused.

By adopting the method of reducing the input voltage V_{IN} by half using the switched capacitor circuit, and further stepping down the obtained intermediate voltage V_{MID} using the synchronous buck converter, it is possible to obtain high efficiency.

For instance, a case is supposed in which the output voltage V_{OUT} of 12 V is generated from the input voltage V_{IN} of 48 V. As a reference method, there is a method of stepping down 48 V to 12 V directly using a simple synchronous buck converter. In the reference method, a square wave voltage (a square wave voltage changing between approximately 0 V and 48 V) is generated by switching the input voltage V_{IN} of 48 V, and the square wave voltage is rectified and smoothed so that the output voltage of 12 V is obtained. In contrast, in the power supply device 1A, a square wave voltage (a square wave voltage changing between approximately 0 V and 24 V) is generated by switching the voltage (V_{IN}/2), and the square wave voltage is rectified and smoothed so that the output voltage of 12 V is obtained. For this reason, compared with the power supply device according to the reference method, the power supply device 1A can suppress a switching loss to be low.

There are a plurality of factors for the switching loss, and some of them are exemplified below. In the reference method, a switching duty ratio is relatively small. If the switching duty ratio is relatively small, an influence of a loss in a period during which an instantaneous value increases and a loss in a period during which the same is decreased are relatively large, in the square wave voltage. In contrast, if the power supply device 1A is used, the input voltage to the synchronous buck converter is the voltage (V_{IN}/2), and hence the switching duty ratio is relatively large compared with the reference method, which improves the switching loss. In addition, in the switching process, charge and discharge of various parasitic capacitances are generated, and in the power supply device 1A, because the input voltage to the synchronous buck converter is the voltage (V_{IN}/2), a loss accompanying the charge and discharge of the parasitic capacitance can be suppressed to be relatively low compared with the reference method.

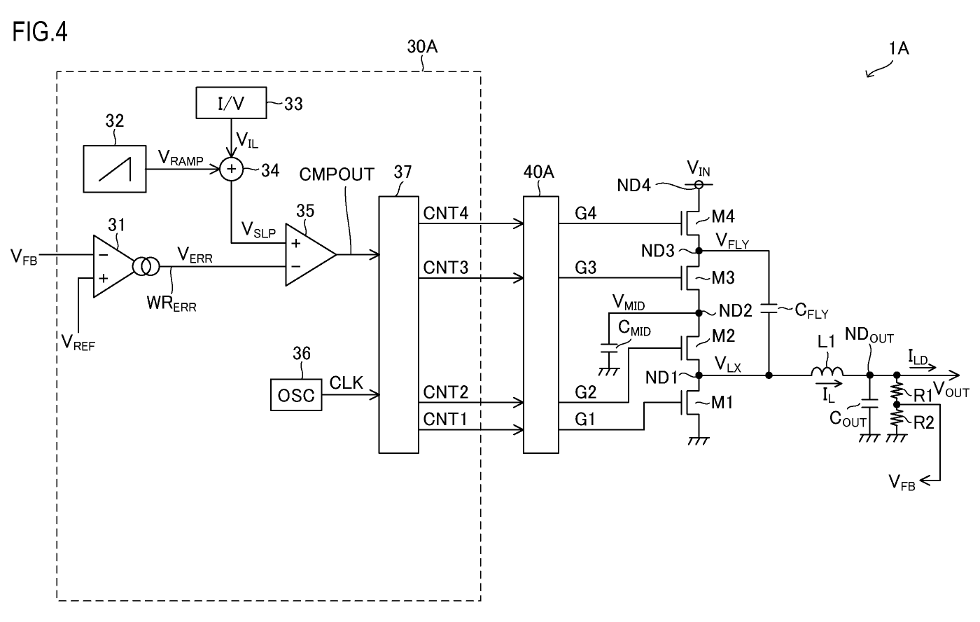

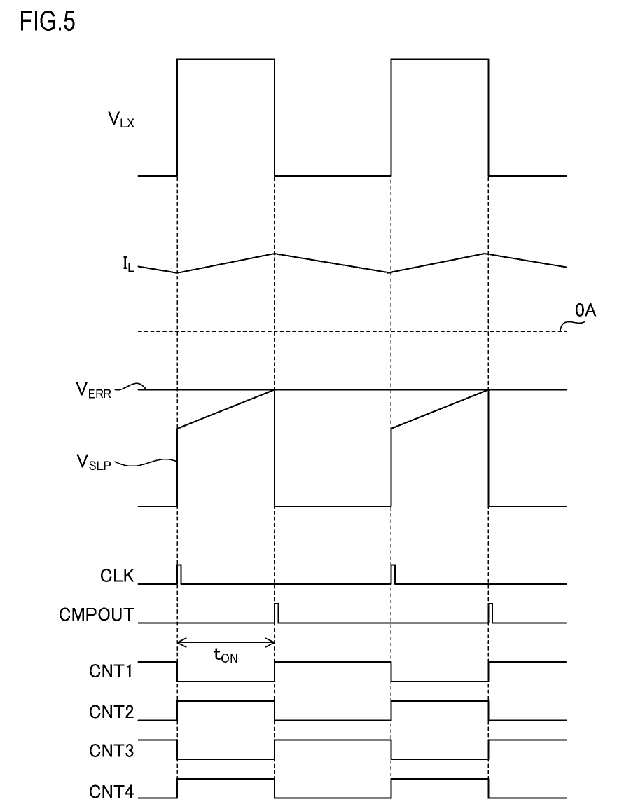

FIG. 4 illustrates a configuration diagram of the power supply device 1A, in which an internal configuration example of the control circuit 30A is shown. Here, it is supposed that the power supply device 1A operates in a current continuous mode in which "I_{L} > 0" holds always, and only a configuration related to the current continuous mode is described unless otherwise noted. FIG. 5 illustrates waveforms of the voltage V_{LX}, the inductor current I_{L}, an error voltage V_{ERR}, a slope voltage V_{SLP}, and signals CLK, CMPOUT, CNT1, CNT2, CNT3, and CNT4, from top to bottom.

The control circuit 30A includes an error amplifier 31, a ramp circuit 32, a current information acquisition circuit 33, an adder 34, a PWM comparator 35, an oscillation circuit (clock generation circuit) 36, and a controller 37. In addition, the power supply device 1A is provided with resistors R1 and R2. A first terminal of the resistor R1 is connected to the output node ND_{OUT}, a second terminal of the resistor R1 is connected to a first terminal of the resistor R2, and a second terminal of the resistor R2 is connected to the ground. A feedback voltage V_{FB} corresponding to the output voltage V_{OUT} is generated at a connection node of the resistors R1 and R2. The feedback voltage V_{FB} is a divided voltage of the output voltage V_{OUT}, and therefore is proportional to the output voltage V_{OUT}. The resistors R1 and R2 constitutes a feedback voltage generation circuit that generates the feedback voltage V_{FB}. The feedback voltage V_{FB} is supplied to the control circuit 30A. However, the feedback voltage generation circuit may be understood to be included in components of the control circuit 30A. In addition, it may be possible that the output voltage V_{OUT} itself is the feedback voltage V_{FB}. In any case, the feedback voltage V_{FB} contains information of the output voltage V_{OUT} (in detail, information indicating a value of the output voltage V_{OUT}).

The error amplifier 31 is a transconductance amplifier of a current output type. The error amplifier 31 includes an inverting input terminal, a non-inverting input terminal, and an output terminal. The feedback voltage V_{FB} is supplied to the inverting input terminal of the error amplifier 31. The non-inverting input terminal of the error amplifier 31 is supplied with a predetermined reference voltage V_{REF}. The reference voltage V_{REF} is a DC voltage having a positive predetermined voltage value, and is generated by a not shown reference voltage generation circuit in the control circuit 30A. The output terminal of the error amplifier 31 is connected to a wiring WR_{ERR}. Note that when the power supply device 1A is activated, a soft start control may be performed in which a value of the reference voltage V_{REF} is gradually increased from 0 V to the positive predetermined voltage value, but in the following description, it is ignored that there is the soft start control.

The error amplifier 31 outputs from its own output terminal a current signal corresponding to a difference between the feedback voltage V_{FB} and the reference voltage V_{REF}, so as to allow the wiring WR_{ERR} to generate the error voltage V_{ERR} corresponding to the difference between the feedback voltage V_{FB} and the reference voltage V_{REF}. Specifically, the error amplifier 31 outputs a current from its own output terminal to the wiring WR_{ERR} so that the error voltage V_{ERR} is increased, if the feedback voltage V_{FB} is lower than the reference voltage V_{REF}, while it pulls in a current from the wiring WR_{ERR} to its own output terminal so that the error voltage V_{ERR} is decreased, if the feedback voltage V_{FB} is higher than the reference voltage V_{REF}. Note that although not particularly illustrated, a phase compensation circuit including a capacitor may be connected between the wiring WR_{ERR} and the ground.

The ramp circuit 32 generates a ramp voltage V_{RAMP}, which simply increases from a predetermined initial voltage V_{INT} with a predetermined change rate during ON period of the transistor M2. In the ramp circuit 32, the initial voltage V_{INT} is 0 V for example, but it can be different from 0 V. During OFF period of the transistor M2, the ramp voltage V_{RAMP} is fixed to the initial voltage V_{INT}.

The current information acquisition circuit 33 acquires current information of the inductor L1, and generates a sense voltage V_{IL} indicating the current information of the inductor L1. The current information of the inductor L1 is information indicating a value of the inductor current I_{L}. The sense voltage V_{IL} has a voltage value proportional to the value of the inductor current I_{L} with a positive proportionality coefficient. Therefore, the sense voltage V_{IL} increases along with an increase in the inductor current I_{L}, while the sense voltage V_{IL} decreases along with a decrease in the inductor current I_{L}. For instance, "V_{IL} = k_{IV} × I_{L}" holds, where k_{IV} is a predetermined positive coefficient.

As long as the sense voltage V_{IL} indicates the current information of the inductor L1, the method of generating the sense voltage V_{IL} is arbitrary. For instance, the sense voltage V_{IL} may be generated by directly detecting the inductor current I_{L} using a current sensor. Here, the current sensor may be a shunt resistor (not shown) inserted between the inductor L1 and the node ND1 in series. Alternatively, for example, the sense voltage V_{IL} may be generated by detecting the current flowing in the transistor M2 during ON period of the transistor M2 (i.e., the inductor current I_{L}), or by detecting the current flowing in the transistor M1 during ON period of the transistor M1 (i.e., the inductor current I_{L}). Other than that, the sense voltage V_{IL} may be generated by detecting the voltage at any point where the voltage corresponding to the inductor current I_{L} is generated.

The adder 34 adds the sense voltage V_{IL} to the ramp voltage V_{RAMP} so as to generate the sum voltage of them as the slope voltage V_{SLP}. In other words, "V_{SLP} = V_{RAMP} + V_{IL}" holds.

The PWM comparator 35 compares the error voltage V_{ERR} with the slope voltage V_{SLP}, so as to generate and output the signal CMPOUT indicating the comparison result. The error voltage V_{ERR} is input to an inverting input terminal of the PWM comparator 35, and the slope voltage V_{SLP} is input to a non-inverting input terminal of the PWM comparator 35. The PWM comparator 35 outputs the signal CMPOUT of low level when "V_{SLP} < V_{ERR}" holds, and outputs the signal CMPOUT of high level when "V_{SLP} > V_{ERR}" holds. When "V_{SLP} = V_{ERR}" holds, the signal CMPOUT has low level or high level.

An oscillation circuit 36 generates and outputs the clock signal CLK by an oscillation operation. The clock signal CLK is a square wave signal having a predetermined frequency f_{PWM}, and has a signal level of alternate high level and low level. The clock signal CLK has an arbitrary duty ratio. Here, it is supposed that the clock signal CLK has low level in principle, and has high level for a very short period of time at an interval that is the reciprocal of the frequency f_{PWM} (see FIG. 5).

The signal CMPOUT and the clock signal CLK are input to the controller 37. By a trigger of a predetermined level change in the clock signal CLK, the controller 37 allows the control signals CNT2 and CNT4 to generate rising edges (i.e., changes the levels of the control signals CNT2 and CNT4 from low level to high level), and allows the control signals CNT1 and CNT3 to generate falling edges (i.e., changes the levels of the control signals CNT1 and CNT3 from high level to low level). Here, the predetermined level change in the clock signal CLK is a change from low level to high level of the clock signal CLK, but it may be a change from high level to low level of the clock signal CLK. The control signals CNT1 to CNT4 are supplied from the controller 37 to the driving circuit 40A. The driving circuit 40A allows also the gate signals G2 and G4 to generate rising edges, by a trigger of rising edges of the control signals CNT 2 and CNT4, so as to turn on the transistors M2 and M4, and allows also the gate signals G1 and G3 to generate falling edges, by a trigger of falling edges of the control signals CNT1 and CNT3, so as to turn off the transistors M1 and M3.

After turning on of the transistors M2 and M4 and turning off of the transistors M1 and M3, the slope voltage V_{SLP} is simply increased, and the state where "V_{SLP} < V_{ERR}" holds is changed to the state where "V_{SLP} > V_{ERR}" holds, so that a rising edge is generated on the signal CMPOUT. If a rising edge is generated on the signal CMPOUT in the switching control, the controller 37 allows the control signals CNT2 and CNT4 to generate falling edges, and allows the control signals CNT1 and CNT3 to generate rising edges. The driving circuit 40A allows also the gate signals G2 and G4 to generate falling edges, by a trigger of falling edges of the control signals CNT2 and CNT4, so as to turn off the transistors M2 and M4, and allows also the gate signals G1 and G3 to generate rising edges, by a trigger of rising edges of the control signals CNT1 and CNT3, so as to turn on the transistors M1 and M3.

Along with turning off of the transistor M2, the ramp voltage V_{RAMP} is decreased to the initial voltage V_{INT} that is sufficiently low, and hence the state where "V_{SLP} < V_{ERR}" holds is restored, and a falling edge is promptly generated on the signal CMPOUT. Note that in the switching control, the period of time after the transistors M2 and M4 are turned on while the transistors M1 and M3 are turned off, until the transistors M2 and M4 are turned off while the transistors M1 and M3 are turned on, is referred to as a time t_{ON}.

If "V_{OUT} = V_{TG}" holds, "V_{FB} = V_{REF}" holds. If "V_{OUT} < V_{TG}" holds through an increase in the load current I_{LD} from the start point of the state where "V_{OUT} = V_{TG}" holds, "V_{FB} < V_{REF}" holds, and hence the error voltage V_{ERR} is increased. The increase in the error voltage V_{ERR} causes an increase in the ON period of the transistor M2. When ON period of the transistor M2 is increased, the inductor current I_{L} is increased, and as a result, the output voltage V_{OUT} is increased toward the target voltage V_{TG}. On the contrary, if "V_{OUT} > V_{TG}" holds through a decrease in the load current I_{LD} from the start point of the state where "V_{OUT} = V_{TG}" holds, "V_{FB} > V_{REF}" hold, and hence the error voltage V_{ERR} is decreased. The decrease in the error voltage V_{ERR} causes a decrease in the ON period of the transistor M2. When ON period of the transistor M2 is decreased, the inductor current I_{L} is decreased, and as a result, the output voltage V_{OUT} is decreased toward the target voltage V_{TG}. In this way, in the switching control, it is controlled so that a difference between the output voltage V_{OUT} and the target voltage V_{TG} is decreased.

The time t_{ON} described above depends on the error voltage V_{ERR} (i.e., depends on the information of the output voltage V_{OUT}), and depends on the sense voltage V_{IL} (i.e., depends on the current information of the inductor L1). In other words, the controller 37 performs the switching control of the transistors M1 to M4 in synchronization with the clock signal CLK, on the basis of the information of the output voltage V_{OUT} and the current information of the inductor L1. In the switching control, the controller 37 uses the driving circuit 40A so as to turn on the transistors M2 and M4 and turn off the transistors M1 and M3, by a trigger of the predetermined level change in the clock signal CLK, and after that, when the time t_{ON} elapses, which corresponds to the information of the output voltage V_{OUT} and the current information of the inductor L1, the transistors M2 and M4 are turned off while the transistors M1 and M3 are turned on.

By the switching control described above, the controller 37 generates the intermediate voltage V_{MID} across both terminals of the capacitor C_{MID}, and controls the buck converter including the transistors M1 and M2 and the inductor L1 to step down the intermediate voltage V_{MID}, so as to generate the output voltage V_{OUT} at the output node ND_{OUT}.

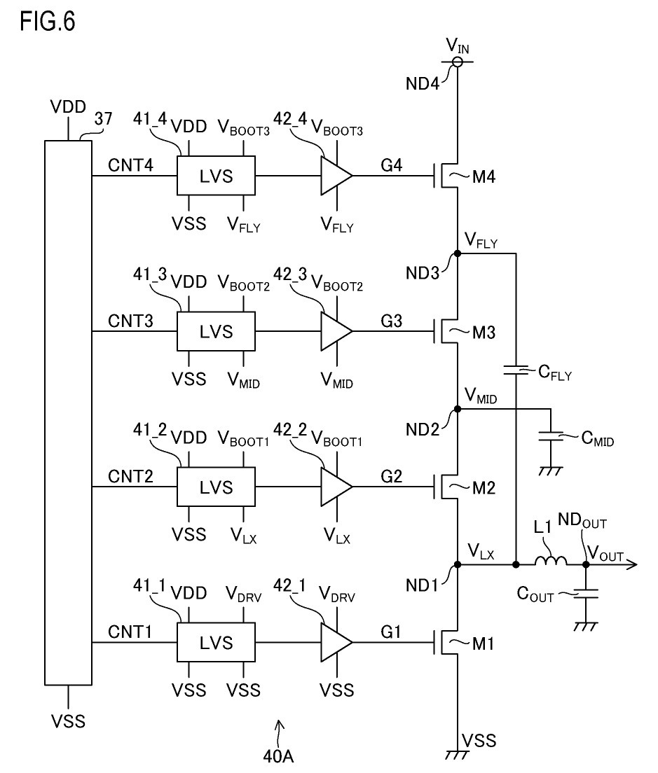

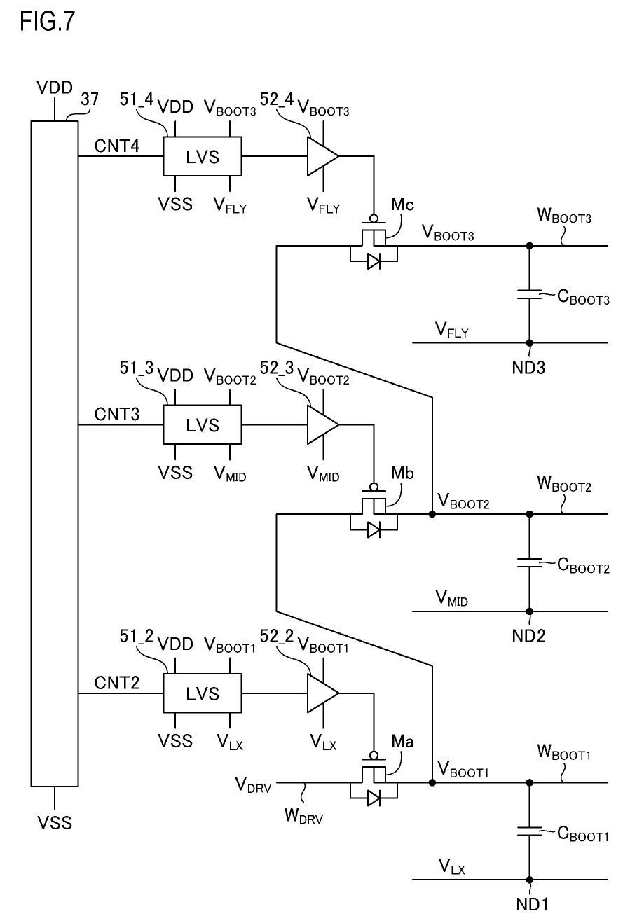

FIG. 6 illustrates an internal configuration of the driving circuit 40A. The driving circuit 40A includes level shifters 41_1 to 41_4 and gate drivers 42_1 to 42_4. FIG. 7 illustrates an internal configuration of the step-up circuit 50A. The step-up circuit 50A includes boot switches Ma, Mb, and Mc, boot capacitors C_{BOOT1}, C_{BOOT2}, and C_{BOOT3}, level shifters 51_2 to 51_4, and gate drivers 52_2 to 52_4. However, it may be possible to allow the level shifters 41_2 to 41_4 and the gate drivers 42_2 to 42_4 to work as the level shifters 51_2 to 51_4 and the gate drivers 52_2 to 52_4.

Each component of the control circuit 30A (i.e., the controller 37) operates using a voltage VDD as a positive side power supply voltage and a voltage VSS as a negative side power supply voltage. Here, the voltage VSS corresponds to the ground voltage. The voltage VDD and a voltage V_{DRV} described later are positive DC voltages lower than the input voltage V_{IN}, and may be generated in the power supply device 1A on the basis of the input voltage V_{IN}. The voltages VDD and V_{DRV} may have different voltage values. Hereinafter, the voltage V_{DRV} can also be referred to as a drive voltage. The drive voltage V_{DRV} is a voltage at a drive wiring W_{DRV}.

Boot wirings W_{BOOT1}, W_{BOOT2}, and W_{BOOT3}, and the drive wiring W_{DRV} may also be understood to be included in components of the step-up circuit 50A. A voltage at the boot wiring W_{BOOT1} is referred to as a boot voltage V_{BOOT1}. A voltage at the boot wiring W_{BOOT2} is referred to as a boot voltage V_{BOOT2}. A voltage at the boot wiring W_{BOOT3} is referred to as a boot voltage V_{BOOT3}. The boot voltages V_{BOOT1}, V_{BOOT2}, and V_{BOOT3} are voltages supplied to the gates of the transistors M2, M3, and M4 so as to turn on the transistors M2, M3, and M4, respectively.

With reference to FIG. 6, the controller 37 outputs the control signals CNT1 to CNT4 to the level shifters 41_1 to 41_4, respectively. As for each of the control signals CNT1 to CNT4, the control signal of high level output from the controller 37 has the level of the voltage VDD, while the control signal of low level output from the controller 37 has the level of the voltage VSS.

The level shifter 41_1 is connected to the wirings applied with the voltages VDD, VSS, and V_{DRV}, and receives supply of the voltages. The level shifter 41_1 uses the voltages VDD, VSS, and V_{DRV} so as to shift a level of the control signal CNT1 from the controller 37, and outputs the control signal CNT1 after level shifting. An output signal of the level shifter 41_1 is supplied to the gate driver 42_1. The output signal of the level shifter 41_1 has high level when the control signal CNT1 of high level is output from the controller 37, and it has low level when the control signal CNT1 of low level is output from the controller 37. The high level of the output signal of the level shifter 41_1 is the level of the drive voltage V_{DRV}, and the low level of the output signal of the level shifter 41_1 is the level of the voltage VSS.

The gate driver 42_1 is connected to the gate of the transistor M1. The gate driver 42_1 drives the gate of the transistor M1 on the basis of the voltages V_{DRV} and VSS, in accordance with the control signal CNT1 (specifically, in accordance with the control signal CNT1 after level shifting from the level shifter 41_1), so as to turn on or off the transistor M1. When the output signal of the level shifter 41_1 has high level, the gate driver 42_1 supplies the gate signal G1 of high level to the gate of the transistor M1, so as to set the state of the transistor M1 to be ON. When the output signal of the level shifter 41_1 has low level, the gate driver 42_1 supplies the gate signal G1 of low level to the gate of the transistor M1, so as to set the state of the transistor M1 to be OFF. The gate signal G1 of high level has a level of the drive voltage V_{DRV}, the gate signal G1 of low level has a level of the voltage VSS. The drive voltage V_{DRV} is higher than the gate threshold voltage of the transistor M1.

The level shifter 41_2 is connected to the wirings applied with the voltages VDD, VSS, V_{BOOT1}, and V_{LX}, and receives supply of the voltages. The level shifter 41_2 uses the voltages VDD, VSS, V_{BOOT1}, and V_{LX} so as to shift a level of the control signal CNT2 from the controller 37, and outputs the control signal CNT2 after level shifting. An output signal of the level shifter 41_2 is supplied to the gate driver 42_2. The output signal of the level shifter 41_2 has high level when the control signal CNT2 of high level is output from the controller 37, and it has low level when the control signal CNT2 of low level is output from the controller 37. The high level of the output signal of the level shifter 41_2 is the level of the boot voltage V_{BOOT1}, and the low level of the output signal of the level shifter 41_2 is the level of the voltage V_{LX}.

The gate driver 42_2 is connected to the gate of the transistor M2. The gate driver 42_2 drives the gate of the transistor M2 on the basis of the voltages V_{BOOT1} and V_{LX}, in accordance with the control signal CNT2 (specifically, in accordance with the control signal CNT2 after level shifting from the level shifter 41_2), so as to turn on or off the transistor M2. When the output signal of the level shifter 41_2 has high level, the gate driver 42_2 supplies the gate signal G2 of high level to the gate of the transistor M2, so as to set the state of the transistor M2 to be ON. When the output signal of the level shifter 41_2 has low level, the gate driver 42_2 supplies the gate signal G2 of low level to the gate of the transistor M2, so as to set the state of the transistor M2 to be OFF. The gate signal G2 of high level has the level of the boot voltage V_{BOOT1}, and the gate signal G2 of low level has the level of the voltage V_{LX}. A difference voltage (V_{BOOT1} - V_{LX}) is higher than the gate threshold voltage of the transistor M2.

The level shifter 41_3 is connected to the wirings applied with the voltages VDD, VSS, V_{BOOT2}, and V_{MID}, and receives supply of the voltages. The level shifter 41_3 uses the voltages VDD, VSS, V_{BOOT2}, and V_{MID}, so as to shift a level of the control signal CNT3 from the controller 37, and outputs the control signal CNT3 after level shifting. An output signal of the level shifter 41_3 is supplied to the gate driver 42_3. The output signal of the level shifter 41_3 has high level when the control signal CNT3 of high level is output from the controller 37, and it has low level when the control signal CNT3 of low level is output from the controller 37. The high level of the output signal of the level shifter 41_3 is the level of the boot voltage V_{BOOT2}, and the low level of the output signal of the level shifter 41_3 is the level of the intermediate voltage V_{MID}.

The gate driver 42_3 is connected to the gate of the transistor M3. The gate driver 42_3 drives the gate of the transistor M3 on the basis of the voltages V_{BOOT2} and V_{MID}, in accordance with the control signal CNT3 (specifically, in accordance with the control signal CNT3 after level shifting from the level shifter 41_3), so as to turn on or off the transistor M3. When the output signal of the level shifter 41_3 has high level, the gate driver 42_3 supplies the gate signal G3 of high level to the gate of the transistor M3, so as to set the state of the transistor M3 to be ON. When the output signal of the level shifter 41_3 has low level, the gate driver 42_3 supplies the gate signal G3 of low level to the gate of the transistor M3, so as to set the state of the transistor M3 to be OFF. The gate signal G3 of high level has the level of the boot voltage V_{BOOT2}, and the gate signal G3 of low level has the level of the intermediate voltage V_{MID}. A difference voltage (V_{BOOT2} - V_{MID}) is higher than the gate threshold voltage of the transistor M3.

The level shifter 41_4 is connected to the wirings applied with the voltages VDD, VSS, V_{BOOT3}, and V_{FLY}, and receives supply of the voltages. The level shifter 41_4 uses the voltages VDD, VSS, V_{BOOT3}, and V_{FLY}, so as to shift a level of the control signal CNT4 from the controller 37, and outputs the control signal CNT4 after level shifting. An output signal of the level shifter 41_4 is supplied to the gate driver 42_4. The output signal of the level shifter 41_4 has high level when the control signal CNT4 of high level is output from the controller 37, and it has low level when the control signal CNT4 of low level is output from the controller 37. The high level of the output signal of the level shifter 41_4 is the level of the boot voltage V_{BOOT3}, and the low level of the output signal of the level shifter 41_4 is the level of the voltage V_{FLY}.

The gate driver 42_4 is connected to the gate of the transistor M4. The gate driver 42_4 drives the gate of the transistor M4 on the basis of the voltages V_{BOOT3} and V_{FLY}, in accordance with the control signal CNT4 (specifically, in accordance with the control signal CNT4 after level shifting from the level shifter 41_4), so as to turn on or off the transistor M4. When the output signal of the level shifter 41_4 has high level, the gate driver 42_4 supplies the gate signal G4 of high level to the gate of the transistor M4, so as to set the state of the transistor M4 to be ON. When the output signal of the level shifter 41_4 has low level, the gate driver 42_4 supplies the gate signal G4 of low level to the gate of the transistor M4, so as to set the state of the transistor M4 to be OFF. The gate signal G4 of high level has the level of the boot voltage V_{BOOT3}, and the gate signal G4 of low level has the level of the voltage V_{FLY}. A difference voltage (V_{BOOT3} - V_{FLY}) is higher than the gate threshold voltage of the transistor M4.

With reference to FIG. 7, the boot switches Ma to Mc are each constituted of a P-channel type MOSFET. For this reason, hereinafter, the boot switches Ma to Mc may be referred to as transistors Ma to Mc. In FIG. 7, parasitic diodes added to the transistors Ma to Mc are also illustrated (the same is true in some drawings described later, in which the transistors Ma to Mc are illustrated). In each of the transistors Ma to Mc, the parasitic diode has a forward direction from the drain to the source.

The boot capacitor C_{BOOT1} is disposed between the node ND1 and the boot wiring W_{BOOT1}. In other words, a first terminal and a second terminal of the boot capacitor C_{BOOT1} are connected to the node ND1 and the boot wiring W_{BOOT1}, respectively. The boot capacitor C_{BOOT1} is charged by a current flowing from the boot wiring W_{BOOT1} to the node ND1 through the boot capacitor C_{BOOT1}, and the boot capacitor C_{BOOT1} is discharged by a current in the opposite direction. By the charging of the boot capacitor C_{BOOT1}, the boot voltage V_{BOOT1} is increased.

The boot capacitor C_{BOOT2} is disposed between the node ND2 and the boot wiring W_{BOOT2}. In other words, a first terminal and a second terminal of the boot capacitor C_{BOOT2} are connected to the node ND2 and the boot wiring W_{BOOT2}, respectively. The boot capacitor C_{BOOT2} is charged by a current flowing from the boot wiring W_{BOOT2} to the node ND2 through the boot capacitor C_{BOOT}₂, and the boot capacitor C_{BOOT2} is discharged by a current in the opposite direction. By the charging of the boot capacitor C_{BOOT2}, the boot voltage V_{BOOT2} is increased.

The boot capacitor C_{BOOT3} is disposed between the node ND3 and the boot wiring W_{BOOT3}. In other words, a first terminal and a second terminal of the boot capacitor C_{BOOT3} are connected to the node ND3 and the boot wiring W_{BOOT3}, respectively. The boot capacitor C_{BOOT3} is charged by a current flowing from the boot wiring W_{BOOT3} to the node ND3 via the boot capacitor C_{BOOT3}, and the boot capacitor C_{BOOT3} is discharged by a current in the opposite direction. By the charging of the boot capacitor C_{BOOT3}, the boot voltage V_{BOOT3} is increased.

The transistor Ma is disposed between the drive wiring W_{DRV} applied with the drive voltage V_{DRV} and the boot wiring W_{BOOT1}. Specifically, the drain of the transistor Ma is connected to the drive wiring W_{DRV}, and the source of the transistor Ma is connected to the boot wiring W_{BOOT1}. The transistor Mb is disposed between the boot wiring W_{BOOT1} and the boot wiring W_{BOOT2}. Specifically, the drain of the transistor Mb is connected to the boot wiring W_{BOOT1}, and the source of the transistor Mb is connected to the boot wiring W_{BOOT2}. The transistor Mc is disposed between the boot wiring W_{BOOT2} and the boot wiring W_{BOOT3}. Specifically, the drain of the transistor Mc is connected to the boot wiring W_{BOOT2}, and the source of the transistor Mc is connected to the boot wiring W_{BOOT3}.

The controller 37 outputs the control signals CNT2 to CNT4 to the level shifters 51_2 to 51_4, respectively.

The level shifter 51_2 is connected to the wirings applied with the voltages VDD, VSS, V_{BOOT1}, and V_{LX}, and receives supply of the voltages. The level shifter 51_2 uses the voltages VDD, VSS, V_{BOOT1}, and V_{LX}, so as to shift a level of the control signal CNT2 from the controller 37, and outputs the control signal CNT2 after level shifting. An output signal of the level shifter 51_2 is supplied to the switch driver 52_2. The output signal of the level shifter 51_2 has high level when the control signal CNT2 of high level is output from the controller 37, and it has low level when the control signal CNT2 of low level is output from the controller 37. The high level of the output signal of the level shifter 51_2 is the level of the boot voltage V_{BOOT1}, and the low level of the output signal of the level shifter 51_2 is the level of the voltage V_{LX}.

The switch driver 52_2 is connected to the gate of the transistor Ma. The switch driver 52_2 drives the gate of the transistor Ma on the basis of the voltages V_{BOOT1} and V_{LX}, in accordance with the control signal CNT2 (specifically, in accordance with the control signal CNT2 after level shifting from the level shifter 51_2), so as to turn on or off the transistor Ma. When the output signal of the level shifter 51_2 has high level, the switch driver 52_2 supplies the gate signal of high level to the gate of the transistor Ma, so as to set the state of the transistor Ma to be OFF. When the output signal of the level shifter 51_2 has low level, the switch driver 52_2 supplies the gate signal of low level to the gate of the transistor Ma, so as to set the state of the transistor Ma to be ON. The gate signal of high level for the transistor Ma has the level of the boot voltage V_{BOOT1}, and the gate signal of low level for the transistor Ma has the level of the voltage V_{LX}. A difference voltage (V_{BOOT1} - V_{LX}) is larger than the absolute value of the gate threshold voltage of the transistor Ma.

The level shifter 51_3 is connected to the wirings applied with the voltages VDD, VSS, V_{BOOT2}, and V_{MID}, and receives supply of the voltages. The level shifter 51_3 uses the voltages VDD, VSS, V_{BOOT2}, and V_{MID}, so as to shift the level of the control signal CNT3 from the controller 37, and outputs the control signal CNT3 after level shifting. An output signal of the level shifter 51_3 is supplied to the switch driver 52_3. The output signal of the level shifter 51_3 has high level when the control signal CNT3 of high level is output from the controller 37, and it has low level when the control signal CNT3 of low level is output from the controller 37. The high level of the output signal of the level shifter 51_3 is the level of the boot voltage V_{BOOT2}, and the low level of the output signal of the level shifter 51_3 is the level of voltage V_{MID}.

The switch driver 52_3 is connected to the gate of the transistor Mb. The switch driver 52_3 drives the gate of the transistor Mb on the basis of the voltages V_{BOOT2} and V_{MID}, in accordance with the control signal CNT3 (specifically, in accordance with the control signal CNT3 after level shifting from the level shifter 51_3), so as to turn on or off the transistor Mb. When the output signal of the level shifter 51_3 has high level, the switch driver 52_3 supplies the gate signal of high level to the gate of the transistor Mb, so as to set the state of the transistor Mb to be OFF. When the output signal of the level shifter 51_3 has low level, the switch driver 52_3 supplies the gate signal of low level to the gate of the transistor Mb, so as to set the state of the transistor Mb to be ON. The gate signal of high level for the transistor Mb has the level of the boot voltage V_{BOOT2}, and the gate signal of low level for the transistor Mb has the level of voltage V_{MID}. A difference voltage (V_{BOOT2} - V_{MID}) is larger than the absolute value of the gate threshold voltage of the transistor Mb.

The level shifter 51_4 is connected to the wirings applied with the voltages VDD, VSS, V_{BOOT3}, and V_{FLY}, and receives supply of the voltages. The level shifter 51_4 uses the voltages VDD, VSS, V_{BOOT3}, and V_{FLY}, so as to shift a level of the control signal CNT4 from the controller 37, and outputs the control signal CNT4 after level shifting. An output signal of the level shifter 51_4 is supplied to the switch driver 52_4. The output signal of the level shifter 51_4 has high level when the control signal CNT4 of high level is output from the controller 37, and it has low level when the control signal CNT4 of low level is output from the controller 37. The high level of the output signal of the level shifter 51_4 is the level of the boot voltage V_{BOOT3}, and the low level of the output signal of the level shifter 51_4 is the level of the voltage V_{FLY}.

The switch driver 52_4 is connected to the gate of the transistor Mc. The switch driver 52_4 drives the gate of the transistor Mc on the basis of the voltages V_{BOOT3} and V_{FLY}, in accordance with the control signal CNT4 (specifically, in accordance with the control signal CNT4 after level shifting from the level shifter 51_4), so as to turn on or off the transistor Mc. When the output signal of the level shifter 51_4 has high level, the switch driver 52_4 supplies the gate signal of high level to the gate of the transistor Mc, so as to set the state of the transistor Mc to be OFF. When the output signal of the level shifter 51_4 has low level, the switch driver 52_4 supplies the gate signal of low level to the gate of the transistor Mc, so as to set the state of the transistor Mc to be ON. The gate signal of high level for the transistor Mc has the level of the boot voltage V_{BOOT3}, and the gate signal of low level for the transistor Mc has the level of the voltage V_{FLY}. A difference voltage (V_{BOOT3} - V_{FLY}) is larger than the absolute value of the gate threshold voltage of the transistor Mc.

As described above, the level shifters 41_2 to 41_4 and the gate drivers 42_2 to 42_4 may be allowed to function as the level shifters 51_2 to 51_4 and the gate drivers 52_2 to 52_4. In this case, the dedicated level shifters and switch drivers for driving the transistors Ma to Mc are not disposed in the step-up circuit 50A (i.e., the level shifters 51_2 to 51_4 and the gate drivers 52_2 to 52_4 are eliminated from the step-up circuit 50A). Further, it is preferred to supply the gate signal G2 output from the driver 42_2 to the gate of the transistor Ma, and to supply the gate signal G3 output from the driver 42_3 to the gate of the transistor Mb, and to supply the gate signal G4 output from the driver 42_4 to the gate of the transistor Mc.

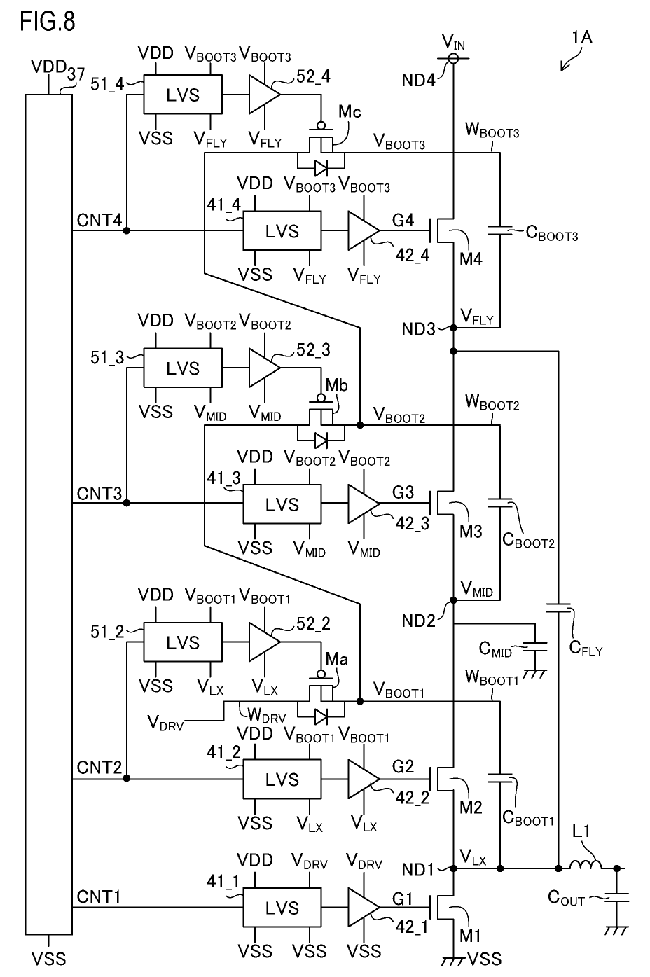

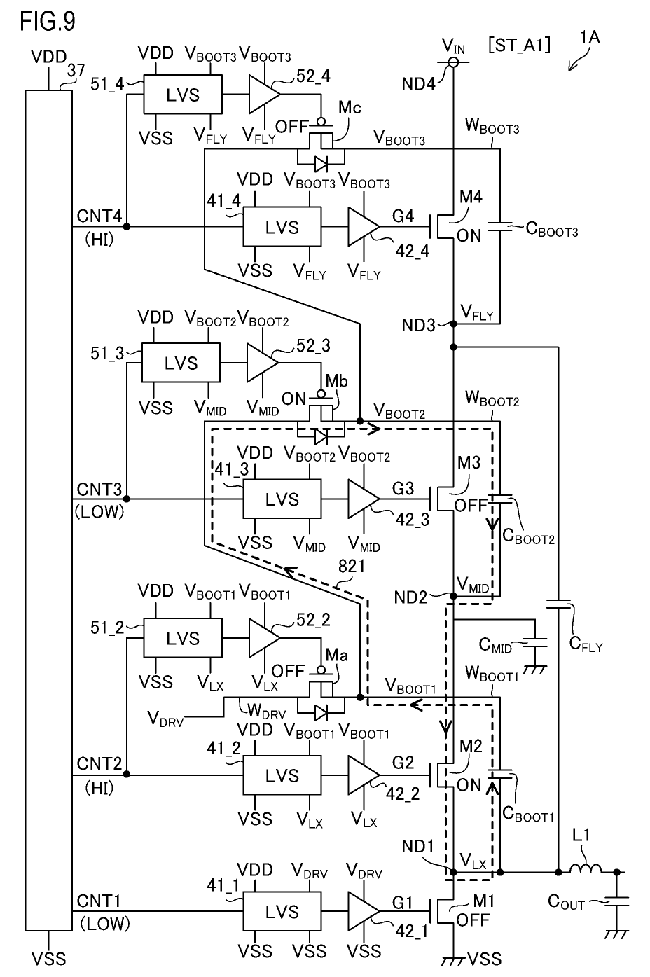

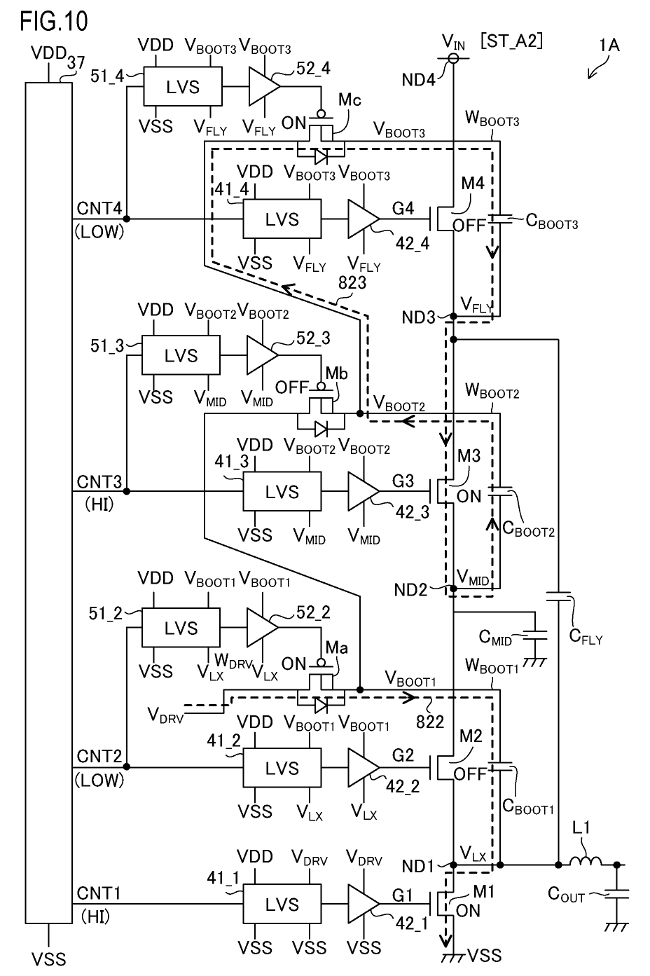

FIG. 8 illustrates an internal configuration of the driving circuit 40A and an internal configuration of the step-up circuit 50A. However, in FIG. 8 and in FIGS. 9 and 10 described later, the reference numerals "40A" and "50A" are not shown.

With reference to FIGS. 9 and 10, an operation of charging or discharging each boot capacitor is described.

As illustrated in FIG. 9, in the state ST_A1, the controller 37 outputs the control signals CNT1 and CNT3 of low level, and outputs the control signals CNT2 and CNT4 of high level. For this reason, in the state ST_A1, on the basis of the control signals CNT1 to CNT4, the driving circuit 40A sets the transistors M1 and M3 to be OFF, and sets the transistors M2 and M4 to be ON. In addition, in the state ST_A1, on the basis of the control signals CNT2 to CNT4, the step-up circuit 50A sets the transistors Ma and Mc to be OFF and sets the transistor Mb to be ON.

As a result, in the state ST_A1, a current 821 is generated. The current 821 is a current that charges the boot capacitor C_{BOOT2}, and is generated by discharging of the boot capacitor C_{BOOT1}. The current 821 flows in a current loop from the boot wiring W_{BOOT1} back to the boot wiring W_{BOOT1} through the transistor Mb, the boot wiring W_{BOOT2}, the boot capacitor C_{BOOT2}, the node ND2, the transistor M2, the node ND1, and the boot capacitor C_{BOOT1}. In addition, in the state ST_A1, the gate signal G2 is boosted up to high level using the discharge current from the boot capacitor C_{BOOT1}, and the gate signal G4 is boosted up to high level using the discharge current from the boot capacitor C_{BOOT3}.

As illustrated in FIG. 10, in the state ST_A2, the controller 37 outputs the control signals CNT1 and CNT3 of high level, and outputs the control signals CNT2 and CNT4 of low level. For this reason, in the state ST_A2, on the basis of the control signals CNT1 to CNT4, the driving circuit 40A sets the transistors M1 and M3 to be ON and sets the transistors M2 and M4 to be OFF. In addition, in the state ST_A2, on the basis of the control signals CNT2 to CNT4, the step-up circuit 50A sets the transistors Ma and Mc to be ON and sets the transistor Mb to be OFF.

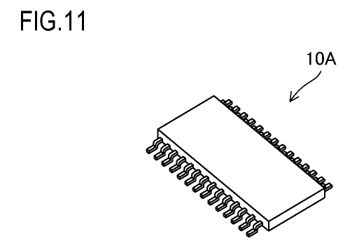

As a result, in the state ST_A2, currents 822 and 823 are generated. The current 822 is a current that charges the boot capacitor C_{BOOT1}, and is generated by a voltage source (not shown) that generates the drive voltage V_{DRV}. The voltage source is a DC voltage source, which is disposed in the power supply device 1A (a power supply control device 10A described later; see FIG. 11), and generates the drive voltage V_{DRV} on the basis of the input voltage V_{IN}. The current 822 flows in a current loop from the voltage source back to the voltage source through the drive wiring W_{DRV}, the transistor Ma, the boot wiring W_{BOOT1}, the boot capacitor C_{BOOT1}, the node ND1, the transistor M1, and the ground. The current 823 is a current that charges the boot capacitor C_{BOOT3}, and is generated by discharging of the boot capacitor C_{BOOT2}. The current 823 flows in a current loop from the boot wiring W_{BOOT2} back to the boot wiring W_{BOOT2} through the transistor Mc, the boot wiring W_{BOOT3}, the boot capacitor C_{BOOT3}, the node ND3, the transistor M3, the node ND2, and the boot capacitor C_{BOOT2}. In addition, in the state ST_A2, the gate signal G3 is boosted up to high level using the discharge current from the boot capacitor C_{BOOT2}.

When performing the switching control for switching the states of the transistors M1 to M4 alternately between the states ST_A1 and ST_A2 (see FIG. 3), the states of the transistors Ma to Mc is also switched as illustrated in FIGS. 9 and 10. In this way, at least in the steady state, the state is maintained in which the difference voltage (V _{BOOT1} - V_{LX}) is higher than the gate threshold voltage of the transistor M2, and the difference voltage (V_{BOOT2} - V_{MID}) is higher than the gate threshold voltage of the transistor M3, and the difference voltage (V_{BOOT3} - V_{FLY}) is higher than the gate threshold voltage of the transistor M4.

FIG. 11 is an external perspective view of the power supply control device 10A included in the power supply device 1A. The power supply control device 10A is an electronic component including a semiconductor chip having a semiconductor integrated circuit formed on a semiconductor substrate, a case (package) housing the semiconductor chip, and a plurality of external terminals exposed from the case to the outside of the power supply control device 10A. By sealing the semiconductor chip in the case (package) made of resin, the power supply control device 10A is formed. Note that the number of the external terminals of the power supply control device 10A and a type of the case of the power supply control device 10A illustrated in FIG. 11 are merely an example, and can be arbitrarily designed.

The power supply device 1A includes the power supply control device 10A and a group of discrete components connected externally to the power supply control device 10A. Some of the components of the power supply device 1A are disposed in the power supply control device 10A, and the others are constituted of the group of discrete components.

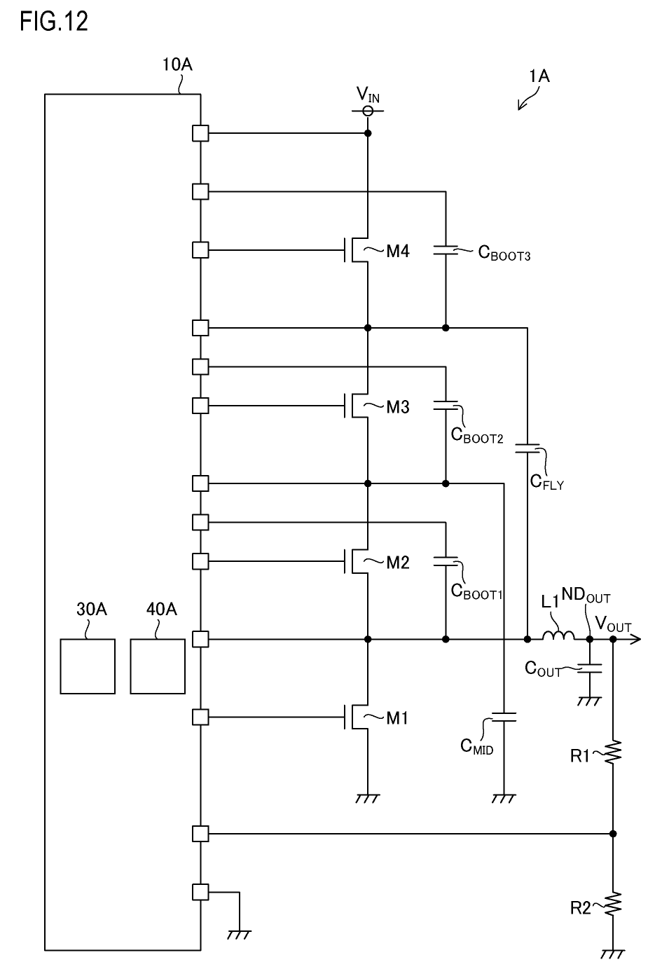

With reference to FIG. 12, the inductor L1, the capacitors C_{OUT}, C_{MID}, C_{FLY}, C_{BOOT1}, C_{BOOT2} and C_{BOOT3}, and the resistors R1 and R2 are disposed in the group of discrete components. However, the resistors R1 and R2 can be disposed in the power supply control device 10A. The transistors M1 to M4 are also included in the group of discrete components. However, the transistors M1 to M4 can be disposed in the power supply control device 10A. The control circuit 30A and the driving circuit 40A are disposed in the power supply control device 10A. The components of the step-up circuit 50A, other than the boot capacitors C_{BOOT1} to C_{BOOT3}, are disposed in the power supply control device 10A.

A reference power supply device (not shown) without the step-up circuit 50A of this embodiment is also considered. In the reference power supply device, three bootstrap diodes are externally connected to the power supply control device. Due to these diodes, the number of components of the reference power supply device is larger than that of the power supply device 1A. In the power supply device 1A, not the diodes but the P-channel type MOSFETs (Ma to Mc) are used as bootstrap rectifier elements, and hence the bootstrap rectifier elements can be included in the power supply control device 10. In other words, the number of components can be reduced, and hence the power supply device can be downsized. In addition, in the reference power supply device, by the forward direction voltage of the diode, the gate signal level for turning on the transistors M2 to M4 is lowered. In contrast, in the power supply device 1A, because there is no influence of the forward direction voltage of the diode, switching losses of the transistors M2 to M4 can be reduced, and a drive margin can be secured in a case where voltages of individual parts are relatively low.

### Second Embodiment

A second embodiment of the present disclosure is described below. The second embodiment and third and fourth embodiments described later are embodiments based on the first embodiment, and for matters that are not particularly described in the second to fourth embodiments, the description in the first embodiment is applied also to the second to fourth embodiments, as long as no contradiction arises. However, when interpreting the description of the second embodiment, if there is a contradiction between the first and the second embodiments, the description in the second embodiment may be prioritized (the same is true for the third and the fourth embodiments described later). Among the first to the fourth embodiments, any plurality of embodiments may be combined, as long as no contradiction arises.

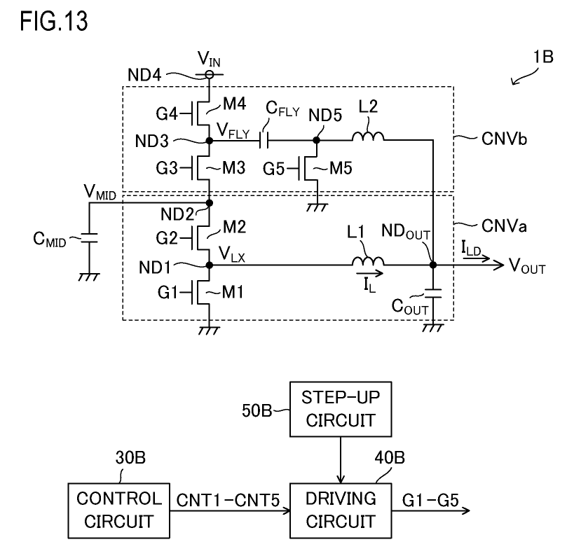

FIG. 13 is an overall configuration diagram of a power supply device 1B according to the second embodiment of the present disclosure. The power supply device 1B is one type of a multiphase converter. The power supply device 1B is constituted by adding a switching element M5 and an inductor L2 to the power supply device 1A according to the first embodiment. Note that when the description in the first embodiment is applied to the second embodiment, "power supply device 1A" in the first embodiment is read as "power supply device 1B" in this embodiment. Along with the addition described above, in the power supply device 1B, the first terminal of the capacitor C_{FLY} is connected to the node ND3, and the second terminal of the capacitor C_{FLY} is connected to a node ND5. The switching element M5 is constituted of an N-channel type MOSFET similarly to the switching elements M1 to M4. For this reason, the switching element M5 may be referred to as the transistor M5 in the following description. In the power supply device 1B, the drain of the transistor M5 and a first terminal of the inductor L2 are connected to the node ND5, a second terminal of the inductor L2 is connected to the output node ND_{OUT}, and the source of the transistor M5 is connected to the ground.

The power supply device 1B includes a buck converter CNVa and a stacked converter CNVb. The buck converter CNVa includes the transistors M1 and M2, the inductor L1, and the capacitor C _{OUT}, and steps down the intermediate voltage V_{MID} so as to generate the desired output voltage V_{OUT}. The transistors M1 and M2 function as a low-side switching element and a high-side switching element in the buck converter CNVa.

The stacked converter CNVb includes the transistors M3 to M5, the capacitor C_{FLY}, and the inductor L2, and generates the intermediate voltage V_{MID} from the input voltage V_{IN}. The capacitor C_{MID} may also be understood to be included in components of the stacked converter CNVb. In addition, the stacked converter CNVb functions also as a converter for one phase in the multiphase converter. The transistor M3 functions as a control switching element for charging the capacitor C_{MID}. The transistor M4 functions as a switching element for generating the intermediate voltage V_{MID}, and functions also as a high-side switching element for multiple phases. The transistor M5 functions as a low-side switching element for multiple phases.

In the power supply device 1B, a control circuit 30B, a driving circuit 40B, and a step-up circuit 50B are disposed, instead of the control circuit 30A, the driving circuit 40A, and the step-up circuit 50A in FIG. 1.

The control circuit 30B performs switching control of the transistors M1 to M5 using the driving circuit 40B, on the basis of the information of the output voltage V_{OUT} and the current information of the inductor L1, so that the output voltage V_{OUT} is stabilized at the target voltage V_{TG}. The information of the output voltage V_{OUT} is information corresponding to the output voltage V_{OUT}, and may be the feedback voltage V_{FB} described above in the first embodiment, for example. The current information of the inductor L1 is information corresponding to the inductor current I_{L}, and is a voltage signal proportional to the value of the inductor current I_{L} (the sense voltage V_{IL} in FIG. 4), for example. The control circuit 30B controls the transistors M1 to M5 to be individually ON or OFF in the switching control. On the basis of the information of the output voltage V_{OUT} and the current information of the inductor L1, the control circuit 30B generates the control signals CNT1 to CNT4 described above, and generates a control signal CNT5 that designates the state of the transistor M5 (ON or OFF state). The driving circuit 40B has the same configuration as the driving circuit 40A in the first embodiment, and generates a gate signal G5 corresponding to the control signal CNT5. The step-up circuit 50B has the same configuration as the step-up circuit 50A in the first embodiment. The driving circuit 40B supplies the gate signals G1 to G5 to the gates of the transistors M1 to M5, respectively, and hence the states of the transistors M1 to M5 are individually set to ON or OFF.

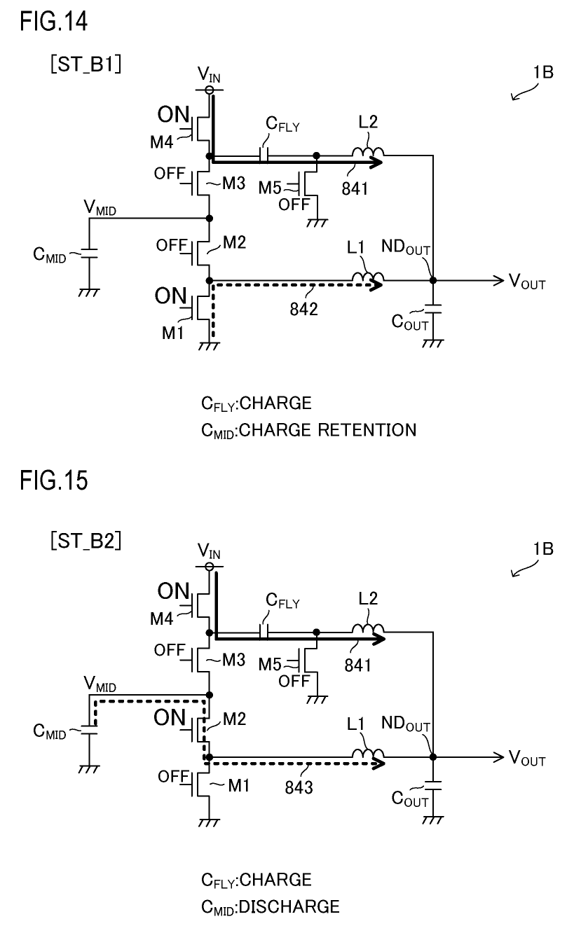

By the switching control performed by the control circuit 30B, the states of the transistors M1 to M5 are switched among states ST_B1 to ST_B4 illustrated in FIGS. 14 to 17. In FIGS. 14 to 17, current flows generated in each state are shown by a plurality of arrow lines. Here, it is supposed that the power supply device 1B is operating in the current continuous mode. Note that with respect to the potential at the second terminal of the capacitor C_{FLY} (i.e., a potential at the node ND5), a current in the direction of increasing the potential at the first terminal of the capacitor C_{FLY} (i.e., the potential at the node ND3) is the charging current for the capacitor C_{FLY}, and a current in the opposite direction thereof is the discharge current for the capacitor C_{FLY}. As for the capacitor C_{MID}, the current in the direction of increasing the intermediate voltage V_{MID} is the charging current, and the current in the direction of decreasing the intermediate voltage V_{MID} is the discharge current.

As illustrated in FIG. 14, in the state ST_B1, the transistors M1 and M4 are ON state, while the transistors M2, M3, and M5 are OFF state. In the state ST_B1, currents 841 and 842 are generated. The current 841 is a current from the application terminal of the input voltage V_{IN} to the output node ND_{OUT} through the transistor M4, the capacitor C_{FLY}, and the inductor L2. The current 841 corresponds to the charging current for the capacitor C_{FLY}, and the capacitor C_{FLY} is charged by the current 841. The current 842 flows from the ground to the output node ND_{OUT} through the transistor M1 and the inductor L1. In the state ST_B1, charge and discharge of the capacitor C_{MID} is not generated, and the accumulated charge of the capacitor C_{MID} is held constant.

As illustrated in FIG. 15, in the state ST_B2, the transistors M2 and M4 are ON state, while the transistors M1, M3 and M5 are OFF state. In the state ST_B2, a current 843 is generated together with the current 841 described above. The current 843 is a current from the capacitor C_{MID} to the output node ND_{OUT} through the transistor M2 and the inductor L1, and is generated by discharging of the capacitor C_{MID}.

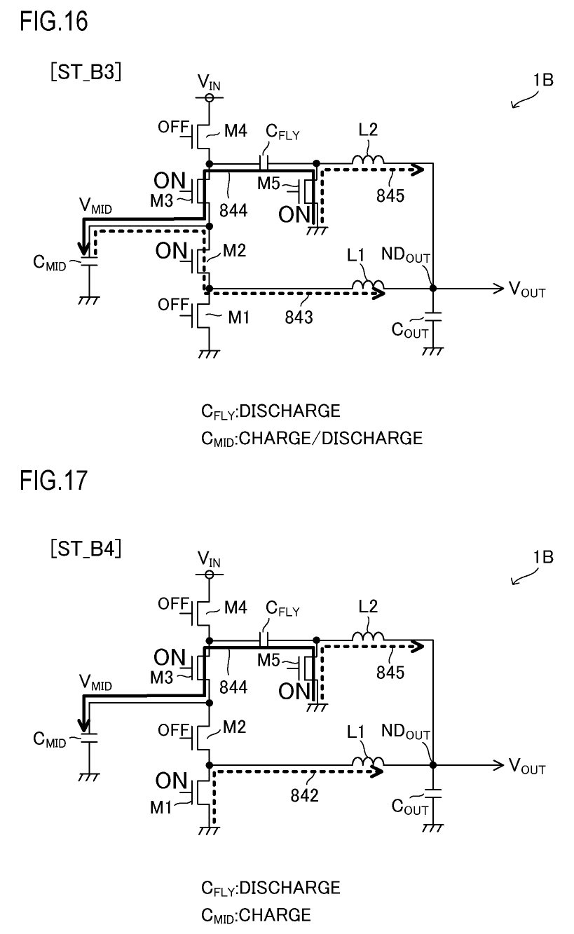

As illustrated in FIG. 16, in the state ST_B3, the transistors M2, M3, and M5 are ON state, while the transistors M1 and M4 are OFF state. In the state ST_B3, currents 844 and 845 are generated together with the current 843 described above. The current 844 flows from the ground to the positive terminal of the capacitor C_{MID} through the transistor M5, the capacitor C_{FLY}, and the transistor M3, and returns to the ground through the capacitor C_{MID}. The current 844 discharges the capacitor C_{FLY}, while it charges the capacitor C_{MID}. The current 845 flows from the ground to the output node ND_{OUT} through the transistor M5 and the inductor L2.

As illustrated in FIG. 17, in the state ST_B4, the transistors M1, M3 and M5 are ON state, while the transistors M2 and M4 are OFF state. In the state ST_B4, the currents 842, 844 and 845 described above are generated.

In the state ST_B1, magnitudes of the currents 841 and 842 are approximately the same. In addition, in the state ST_B2, magnitudes of the currents 841 and 843 are approximately the same. Further, the transistors M2 and M4 are ON in the state ST_B2, and hence the state ST_B2 for the capacitors C_{FLY} and C_{MID} is equivalent to the state where the capacitors C_{FLY} and C_{MID} are connected in series. In addition, in the states ST_B3 and ST_B4, the capacitors C_{FLY} and C_{MID} are connected in parallel through the transistors M3 and M5. As a result, similarly to the power supply device 1A, also in the power supply device 1B, the circuit including the transistors M1 to M5 and the capacitors C_{FLY} and C_{MID} constitutes the switched capacitor circuit. The control circuit 40B allows this circuit to work as the switched capacitor circuit, so as to generate the intermediate voltage V_{MID} corresponding to the divided voltage of the input voltage V_{IN} at the positive terminal of the capacitor C_{MID}. The intermediate voltage V_{MID} is substantially equal to the voltage (V_{IN}/2). To be exact, the intermediate voltage V_{MID} fluctuates a little around the voltage (V_{IN}/2).

The output current (842, 843) to the output node ND_{OUT} by the buck converter CNVa, and the output current (841, 845) to the output node ND_{OUT} by the stacked converter CNVb are pulsating currents, and the former and latter output currents have phases different from each other. In other words, the power supply device 1B is a multiphase converter (a multiphase type DC/DC converter), and the number of phases is two.

The configuration and the operation of the step-up circuit 50B are the same as those of the step-up circuit 50A in the first embodiment (see FIG. 7). Therefore, the transistor Ma is OFF during ON period of the transistor M2, and is ON during OFF period of the transistor M2. The transistor Mb is OFF during ON period of the transistor M3, and is ON during OFF period of the transistor M3. The transistor Mc is OFF during ON period of the transistor M4, and is ON during OFF period of the transistor M4. When noting only the states of the transistors M1 to M4 and Ma to Mc, the state ST_B2 of FIG. 15 is equivalent to the state ST_A1 of FIG. 9, and the state ST_B4 of FIG. 17 is equivalent to the state ST_A2 of FIG. 10.

### Third Embodiment

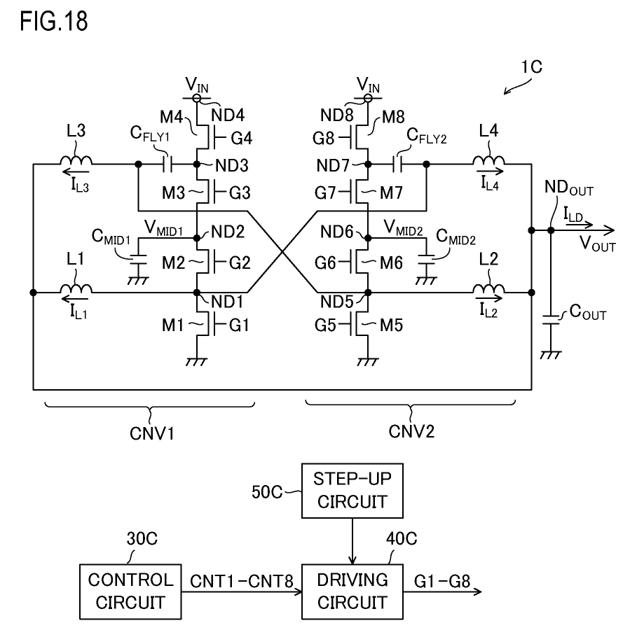

A third embodiment of the present disclosure is described below. FIG. 18 is an overall configuration diagram of a power supply device 1C according to the third embodiment of the present disclosure. Note that the description in the first embodiment can be applied to the third embodiment, and for this application, "the power supply device 1A" in the first embodiment is read as "the power supply device 1C" in this embodiment.

Similarly to the power supply device 1A or 1B, the power supply device 1C receives supply of the positive input voltage V_{IN} from a not shown voltage source, and steps down the input voltage V_{IN} so as to generate the positive output voltage V_{OUT}. The power supply device 1C includes a converter CNV1 and a converter CNV2, a control circuit 30C, a driving circuit 40C, and a step-up circuit 50C. As components of the converter CNV1 and the converter CNV2, the power supply device 1C includes the switching elements M1 to M8, the capacitors C_{FLY1}, C_{FLY2}, C_{MID1}, C_{MID2}, and C_{OUT}, and the inductors L1 to L4. The capacitors C_{FLY1} and C_{FLY2} can be referred to as flying capacitors. The capacitors C_{MID1} and C_{MID2} can be referred to as intermediate capacitors. The capacitor C_{OUT} can be referred to as output capacitor.

The converter CNV1 is a first channel converter. Components of the converter CNV1 include the switching elements M1 to M4, the capacitors C_{FLY1} and C_{MID1}, and the inductors L1 and L3. The converter CNV2 is a second channel converter. Component of the converter CNV2 include the switching elements M5 to M8, the capacitors C_{FLY2} and C_{MID2}, and the inductors L2 and L4. The capacitor C_{OUT} is used by both the converters CNV1 and CNV2. In other words, the capacitor C_{OUT} is a component of each of the converters CNV1 and CNV2, and is shared by the converters CNV1 and CNV2.

Other than the capacitor C_{OUT}, some components in the power supply device 1C are used (i.e., shared) by both the converters CNV1 and CNV2. This is described below in detail.

The converter CNV1 includes a first channel buck converter and a first channel stacked converter. The first channel buck converter includes the switching elements M1 and M2, and the inductor L1, and steps down the intermediate voltage V_{MID1} in cooperation with the capacitor C_{OUT}, so as to generate the output voltage V_{OUT} at the output node ND_{OUT}. When noting an operation of the converter CNV1, the switching elements M1 and M2 function as a low-side switching element and a high-side switching element in the first channel buck converter.

The first channel stacked converter includes the switching elements M3 to M5, the capacitor C_{FLY1} and the inductor L3, and generates the intermediate voltage V_{MID1} from the input voltage V_{IN}. The capacitor C_{MID1} may also be understood to be included in components of the first channel stacked converter. The converter CNV1 itself is a multiphase converter of two phases. The first channel stacked converter functions also as a converter for one phase in the converter CNV1. The switching element M3 functions as a control switching element for charging the capacitor C_{MID1}. The switching element M4 functions as a switching element for generating the intermediate voltage V_{MID1}, and functions also as a high-side switching element for multiple phases. When noting an operation of the converter CNV1, the switching element M5 functions as a low-side switching element for multiple phases.

The converter CNV2 includes a second channel buck converter and a second channel stacked converter. The second channel buck converter includes the switching elements M5 and M6, and the inductor L2, and steps down the intermediate voltage V_{MID2} in cooperation with the capacitor C_{OUT}, so as to generate the output voltage V_{OUT} at the output node ND_{OUT}. When noting an operation of the converter CNV2, the switching elements M5 and M6 function as a low-side switching element and a high-side switching element in the second channel buck converter.

The second channel stacked converter includes the switching elements M7, M8 and M1, the capacitor C_{FLY2}, and the inductor L4, and generates the intermediate voltage V_{MID2} from the input voltage V_{IN}. The capacitor C_{MID2} may also be understood to be included in components of the second channel stacked converter. The converter CNV2 itself is a multiphase converter of two phases. The second channel stacked converter functions also as a converter for one phase in the converter CNV2. The switching element M7 functions as a control switching element for charging the capacitor C_{MID2}. The switching element M8 functions as a switching element for generating the intermediate voltage V_{MID2}, and functions as a high-side switching element for multiple phases. When noting an operation of the converter CNV2, the switching element M1 functions as a low-side switching element for multiple phases.

In the power supply device 1C, the first channel buck converter, the first channel stacked converter, the second channel buck converter, and the second channel stacked converter each supply a current to the output node ND_{OUT}, and thus the output voltage V_{OUT} having a desired voltage value is generated at the output node ND_{OUT}.

As understood from the above description, the switching element M1 works not only as a low-side switching element in the first channel buck converter, but also as a low-side switching element for multiple phases in the second channel stacked converter. Similarly, the switching element M5 works not only as a low-side switching element in the second channel buck converter, but also as a low-side switching element for multiple phases in the first channel stacked converter.

As described above, the converters CNV1 and CNV2 are each a multiphase converter for two phases. In the power supply device 1C, the converters CNV1 and CNV2 operate in parallel. If two power supply devices 1B of FIG. 13 are disposed, total ten switching elements are necessary, while in the power supply device 1C, total eight switching elements can realize the same function as the case where the two power supply devices 1B are operated in parallel, and thus the number of components can be reduced.

The configuration of the power supply device 1C of FIG. 18 is described below in more detail. In this embodiment, the switching elements M1 to M8 are each constituted of an N-channel type MOSFET. For this reason, the switching elements M1 to M8 may be referred to as the transistors M1 to M8 in the following description.

The transistors M1 to M4 are connected in series between the ground and the node ND4. The transistor M1 is disposed between the ground and the node ND1, the transistor M2 is disposed between the nodes ND1 and ND2, the transistor M3 is disposed between the nodes ND2 and ND3, and the transistor M4 is disposed between the nodes ND3 and ND4. More specifically, the source of the transistor M1 is connected to the ground. The drain of the transistor M1 and the source of the transistor M2 are connected to the node ND1. The drain of the transistor M2 and the source of the transistor M3 are connected to the node ND2. The drain of the transistor M3 and the source of the transistor M4 are connected to the node ND3. The drain of the transistor M4 is connected to the node ND4. The signals supplied to the gates of the transistors M1 to M4 are referred to as the gate signals G1 to G4, respectively.

The transistors M5 to M8 are connected in series between the ground and the node ND8. The transistor M5 is disposed between the ground and the node ND5, the transistor M6 is disposed between the nodes ND5 and ND6, the transistor M7 is disposed between the nodes ND6 and ND7, the transistor M8 is disposed between the nodes ND7 and ND8. More specifically, the source of the transistor M5 is connected to the ground. The drain of the transistor M5 and the source of the transistor M6 are connected to the node ND5. The drain of the transistor M6 and the source of the transistor M7 are connected to the node ND6. The drain of the transistor M7 and the source of the transistor M8 are connected to the node ND7. The drain of the transistor M8 is connected to the node ND8. The signals supplied to the gates of the transistors M5 to M8 are referred to as the gate signals G5 to G8, respectively.

The nodes ND4 and ND8 are power supply nodes for receiving the input voltage V_{IN}. In other words, the input voltage V_{IN} is supplied to the nodes ND4 and ND8. Here, the power supply node connected to the drain of the transistor M4 and the power supply node connected to the drain of the transistor M8 are denoted by different reference symbols (ND4, ND8), but the nodes ND4 and ND8 may be a single node, or may be two separated nodes that receive supply of the input voltage V _{IN}.

The capacitor C_{MID1} is disposed between the node ND2 and the ground. In other words, a first terminal of the capacitor C_{MID1} is connected to the node ND2, and a second terminal of the capacitor C_{MID1} is connected to the ground. The first terminal of the capacitor C_{MID1} corresponds to a positive terminal of the capacitor C_{MID1}. The voltage at the node ND2 is the intermediate voltage V_{MID1}. In other words, the capacitor C_{MID1} accumulates charge of the intermediate voltage V_{MID1}.

The capacitor C_{MID2} is disposed between the node ND6 and the ground. In other words, a first terminal of the capacitor C_{MID2} is connected to the node ND6, and a second terminal of the capacitor C_{MID2} is connected to the ground. The first terminal of the capacitor C_{MID2} corresponds to a positive terminal of the capacitor C_{MID2}. The voltage at the node ND6 is the intermediate voltage V_{MID2}. In other words, the capacitor C_{MID2} accumulates charge of the intermediate voltage V_{MID2}.

The inductor L1 is disposed between the node ND1 and the output node ND_{OUT}. In other words, the first terminal of the inductor L1 is connected to the node ND1, and the second terminal of the inductor L1 is connected to the output node ND_{OUT}. The capacitor C_{FLY1} is disposed between the nodes ND3 and ND5. In other words, a first terminal of the capacitor C_{FLY1} is connected to the node ND3, and a second terminal of the capacitor C_{FLY1} is connected to the node ND5. The inductor L3 is disposed between the node ND5 and the output node ND_{OUT}. In other words, a first terminal of the inductor L3 is connected to the node ND5 (i.e., connected to the second terminal of the capacitor C_{FLY1}), and a second terminal of the inductor L3 is connected to the output node ND_{OUT}.

The inductor L2 is disposed between the node ND5 and the output node ND_{OUT}. In other words, the first terminal of the inductor L2 is connected to the node ND5, and the second terminal of the inductor L2 is connected to the output node ND_{OUT}. The capacitor C_{FLY2} is disposed between the nodes ND7 and ND1. In other words, a first terminal of the capacitor C_{FLY2} is connected to the node ND7, and a second terminal of the capacitor C_{FLY2} is connected to the node ND1. The inductor L4 is disposed between the node ND1 and the output node ND_{OUT}. In other words, a first terminal of the inductor L4 is connected to the node ND1 (i.e., connected to the second terminal of the capacitor C_{FLY2}), and a second terminal of the inductor L4 is connected to the output node ND_{OUT}.

The capacitor C_{OUT} is disposed between the output node ND_{OUT} and the ground. In other words, the first terminal of the capacitor C_{OUT} is connected to the output node ND_{OUT}, and a second terminal of the capacitor C_{OUT} is connected to the ground. The first terminal of the capacitor C _{OUT} corresponds to the positive terminal of the capacitor C_{OUT}. The voltage at the output node ND_{OUT} is the output voltage V_{OUT}. In other words, the capacitor C_{OUT} accumulates charge of the output voltage V_{OUT}.

The control circuit 30C performs switching control of the transistors M1 to M8 on the basis of the information of the output voltage V_{OUT}, the current information of the inductor L1, and current information of the inductor L2, so that the output voltage V_{OUT} is stabilized at the target voltage V_{TG}. The switching control of the transistors M1 to M8 by the control circuit 30C and the ON/OFF control of the transistors M1 to M8 are performed using the driving circuit 40C, but the description of the driving circuit 40C may be omitted. The information of the output voltage V_{OUT} is information corresponding to the output voltage V_{OUT}, and may be the feedback voltage V_{FB} described above in the first embodiment, for example. The current information of the inductor L1 is information corresponding to a current flowing in the inductor L1, and is a voltage signal proportional to the current flowing in the inductor L1, for example. The current information of the inductor L2 is information corresponding to a current flowing in the inductor L2, and is a voltage signal proportional to the current flowing in the inductor L2, for example. The control circuit 30C controls the transistors M1 to M8 to be individually ON or OFF in the switching control. The control circuit 30C generate the control signals CNT1 to CNT8 that designate states of the transistors M1 to M8 (ON or OFF state), on the basis of the information of the output voltage V_{OUT} and individual current information of the inductors L1 and L2.

Similarly to the driving circuit 40A in the first embodiment, the driving circuit 40C generates the gate signals G1 to G4 corresponding to the control signals CNT1 to CNT4, and further generates the gate signals G5 to G8 corresponding to the control signals CNT5 to CNT8. As the driving circuit 40C supplies the gate signals G1 to G8 to the gates of the transistors M1 to M8, respectively, the states of the transistors M1 to M8 are individually set to be ON or OFF. The step-up circuit 50C will be described later.

The gate signals G1 to G8 correspond to the control signals CNT1 to CNT8, respectively. Any one of the control signals CNT1 to CNT8 is referred to as a control signal CNTx, and the gate signal corresponding to the control signal CNTx is referred to as a gate signal Gx. One of the transistors M1 to M8, whose gate receives the gate signal Gx, is referred to as a transistor Mx. The driving circuit 40C allows the gate signal Gx to have high level during a high level period of the control signal CNTx, while it allows the gate signal Gx to have low level during a low level period of the control signal CNTx. When the gate signal Gx has high level, the transistor Mx is ON state, and when the gate signal Gx has low level, the transistor Mx is OFF state. Therefore, for example, the transistor M1 is ON state during a high level period of the gate signal G1, and the transistor M1 is OFF state during a low level period of the gate signal G1. Similarly, the transistor M2 is ON state during the high level period of the gate signal G2, and the transistor M2 is OFF state during a low level period of the gate signal G2. The same is true for the transistors M3 to M8. The gate signal Gx of high level has a potential that is higher than a potential higher than the source potential of the transistor Mx by the gate threshold voltage of the transistor Mx. The gate signal Gx of low level may have a potential that is substantially equal to the source potential of the transistor Mx.

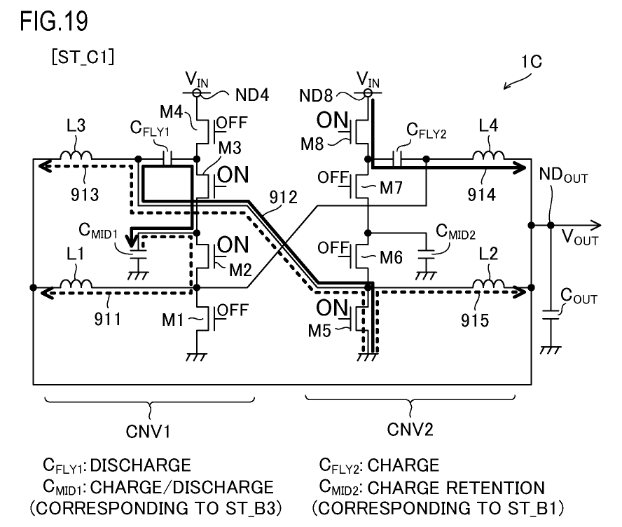

When the control circuit 30C controls the states of the transistors M1 to M8, the desired output voltage V_{OUT} lower than the input voltage V_{IN} is generated at the output node ND_{OUT}. The control circuit 30C sequentially switches the states of the transistors M1 to M8 among states ST_C1 to ST_C4. With reference to FIGS. 19 to 22, the states ST_C1 to ST_C4 are described.

Note that with respect to the potential at the second terminal of the capacitor C_{FLY1} (i.e., the potential at the node ND5), a current in the direction of increasing the potential at the first terminal of the capacitor C_{FLY1} (i.e., the potential at the node ND3) is the charging current for the capacitor C_{FLY1}, and a current in the opposite direction thereof is the discharge current for the capacitor C_{FLY1}. Similarly, with respect to the potential at the second terminal of the capacitor C_{FLY2} (i.e., the potential at the node ND1), a current in the direction of increasing the potential at the first terminal of the capacitor C_{FLY2} (i.e., a potential at the node ND7) is the charging current for the capacitor C_{FLY2}, and a current in the opposite direction thereof is the discharge current for the capacitor C_{FLY2}. As for the capacitor C_{MID1}, a current in the direction of increasing the intermediate voltage V_{MID1} is the charging current, and a current in the direction of decreasing the intermediate voltage V_{MID1} is the discharge current. Similarly, for the capacitor C_{MID2}, a current in the direction of increasing the intermediate voltage V_{MID2} is the charging current, and a current in the direction of decreasing the intermediate voltage V_{MID2} is the discharge current.

In addition, here, it is supposed that the power supply device 1C is operating in the current continuous mode. In the current continuous mode, a current always flows in each of the inductors L1 to L4 from the first terminal to the second terminal. In other words, a current always flows through the inductors L1 to L4 in the direction where the capacitor C_{OUT} is charged in the current continuous mode. The current that flows through the inductor L1 is referred to as an inductor current I_{L1}. Similarly, the currents that flow through the inductor L2, L3, and L4 are referred to as inductor currents I _{L2}, I_{L3}, and I_{L4}, respectively. The output node ND_{OUT} is connected to a not shown load. The load is any load that is driven on the basis of the output voltage V_{OUT}. The current supplied from the output node ND_{OUT} to the load is referred to as the load current I_{LD}. The load current I_{LD} corresponds to the output current of the power supply device 1C.

FIG. 19 illustrates ON/OFF states of the transistors M1 to M8 in a state ST_C1, and current flows generated in the state ST_C1. In the state ST_C1, the control circuit 30C uses the driving circuit 40C so as to control the transistors M2, M3, M5 and M8 to be ON state, while to control the transistors M1, M4, M6 and M7 to be OFF state. The state ST_C1 corresponds to the state ST_B3 of FIG. 16 for the converter CNV1, while it corresponds to the state ST_B1 of FIG. 14 for the converter CNV2.

In the state ST_C1, currents 911 to 913 are generated in the converter CNV1. The current 911 is a current from the capacitor C_{MID1} to the output node ND_{OUT} through the switching element M2 and the inductor L1, and is generated by discharging of the capacitor C_{MID1}. The current 912 flows from the ground to the first terminal of the capacitor C_{MID1} through the switching element M5, the capacitor C_{FLY1}, and the switching element M3, and flows back to the ground through the capacitor C_{MID1}. The current 912 discharges the capacitor C_{FLY1}, while it charges the capacitor C_{MID1}. The current 913 flows from the ground to the output node ND_{OUT} through the switching element M5 and the inductor L3.

In the state ST_C1, currents 914 and 915 are generated in the converter CNV2. The current 914 flows from the node ND8 to the output node ND_{OUT} through the switching element M8, the capacitor C_{FLY2}, and the inductor L4. The current 914 charges the capacitor C_{FLY2}. The current 915 flows from the ground to the output node ND_{OUT} through the switching element M5 and the inductor L2. In the state ST_C1, charge and discharge for the capacitor C_{MID2} is not generated, and the accumulated charge of the capacitor C_{MID2} is held constant.

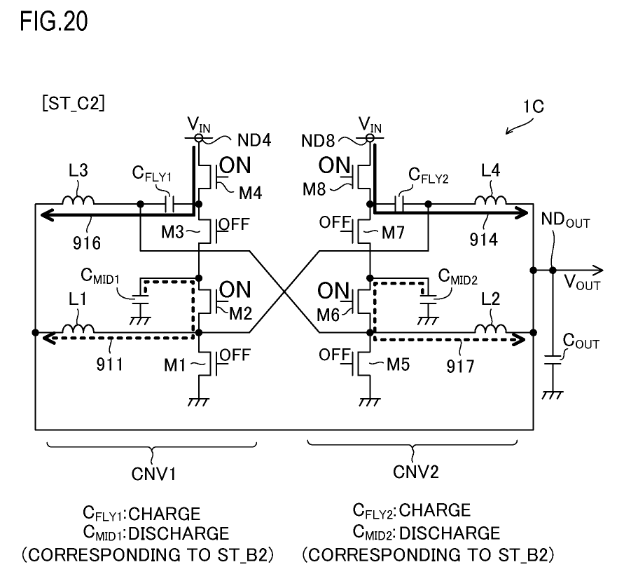

FIG. 20 illustrates ON/OFF states of the transistors M1 to M8 in the state ST_C2 and current flows generated in the state ST_C2. In the state ST_C2, the control circuit 30C uses the driving circuit 40C so as to control the transistors M2, M4, M6 and M8 to be ON state, while to control the transistors M1, M3, M5 and M7 to OFF state. The state ST_C2 corresponds to the state ST_B2 of FIG. 15 for the converter CNV1, and it corresponds to the state ST_B2 of FIG. 15 also for the converter CNV2.

In the state ST_C2, current 916 is generated together with the above current 911 in the converter CNV1. As described above, the current 911 is generated by discharge of the capacitor C_{MID1}. The current 916 flows from the node ND4 to the output node ND_{OUT} through the switching element M4, the capacitor C _{FLY1}, and the inductor L3. The current 916 charges the capacitor C_{FLY1}.

In the state ST_C2, a current 917 is generated together with the above current 914 in the converter CNV2. As described above, the current 914 charges the capacitor C_{FLY2}. The current 917 is a current from the capacitor C_{MID1} to the output node ND_{OUT} through the switching element M6 and the inductor L2, and is generated by discharge of the capacitor C_{MID2}.

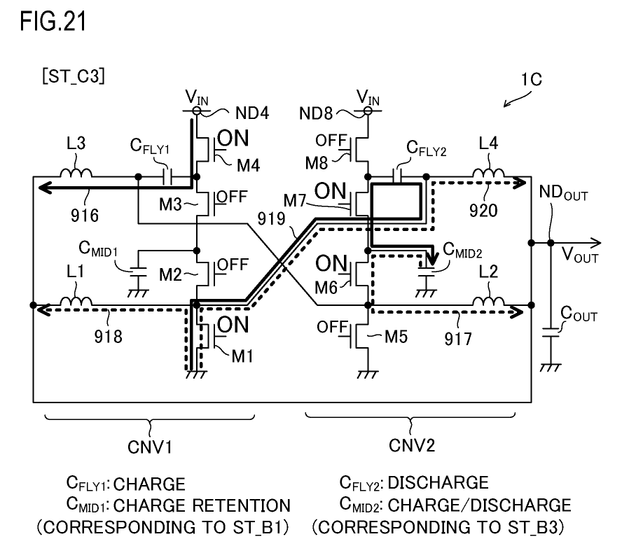

FIG. 21 illustrates ON/OFF states of the transistors M1 to M8 in the state ST_C3 and current flows generated in the state ST_C3. In the state ST_C3, the control circuit 30C uses the driving circuit 40C so as to control the transistors M1, M4, M6 and M7 to be ON state, while to control the transistors M2, M3, M5 and M8 to be OFF state. The state ST_C3 corresponds to the state ST_B1 of FIG. 14 for the converter CNV1, and it corresponds to the state ST_B3 of FIG. 16 for the converter CNV2.

In the state ST_C3, a current 918 is generated together with the above current 916 in the converter CNV1. As described above, the current 916 charges the capacitor C_{FLY1}. The current 918 flows from the ground to the output node ND_{OUT} through the switching element M1 and the inductor L1. In the state ST_C3, charge and discharge for the capacitor C_{MID1} is not generated, and the accumulated charge of the capacitor C_{MID1} is held constant.

In the state ST_C3, currents 919 and 920 are generated together with the above current 917 in the converter CNV2. As described above, the current 917 is generated by discharge of the capacitor C_{MID2}. The current 919 flows from the ground to the first terminal of the capacitor C_{MID2} through the switching element M1, the capacitor C_{FLY2}, and the switching element M7, and flows back to the ground through the capacitor C_{MID2}. The current 919 discharges the capacitor C_{FLY2}, while it charges the capacitor C_{MID2}. The current 920 flows from the ground to the output node ND_{OUT} through the switching element M1 and the inductor L4.

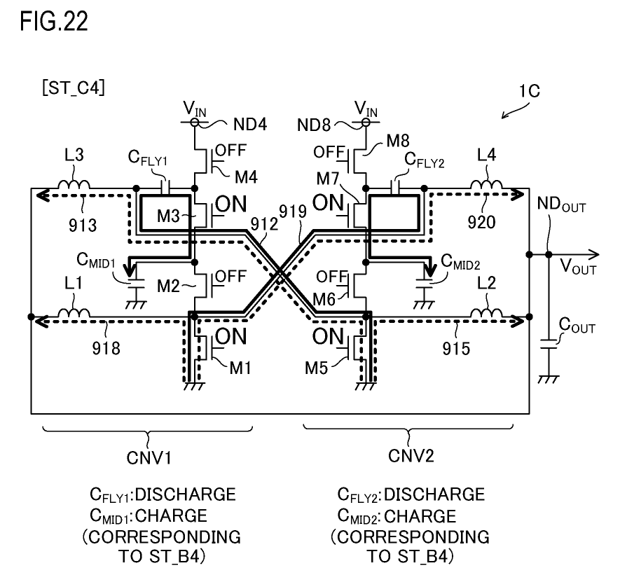

FIG. 22 illustrates ON/OFF states of the transistors M1 to M8 in the state ST_C4 and current flows generated in the state ST_C4. In the state ST_C4, the control circuit 30C uses the driving circuit 40C so as to control the transistors M1, M3, M5 and M7 to be ON state, while to control the transistors M2, M4, M6 and M8 to be OFF state. The state ST_C4 corresponds to the state ST_B4 of FIG. 17 for the converter CNV1, while it corresponds to the state ST_B4 of FIG. 17 also for the converter CNV2.

In the state ST_C4, the above currents 912, 913 and 918 are generated in the converter CNV1. As described above, the current 912 discharges the capacitor C_{FLY1}, while it charges the capacitor C _{MID1}.

In the state ST_C4, the above currents 919, 920, and 915 are generated in the converter CNV2. As described above, the current 919 discharges the capacitor C_{FLY2}, while it charges the capacitor C_{MID2}.

The converter CNV1 is noted. In the state ST_C3, magnitudes of the currents 918 and 916 (i.e., magnitudes of the inductor currents I_{L1} and I_{L3}) are approximately the same. In addition, in the state ST_C2, magnitudes of the currents 911 and 916 (i.e., magnitudes of the inductor currents I_{L1} and I_{L3}) are approximately the same. Further, in the state ST_C2, because the transistors M2 and M4 are ON, the state ST_C2 for the capacitors C_{FLY1} and C_{MID1} is equivalent to the state where the capacitors C_{FLY1} and C_{MID1} are connected in series. In addition, in the states ST_C1 and ST_C4, the capacitors C_{FLY1} and C_{MID1} are connected in parallel through the transistors M3 and M5. As a result, the circuit including the transistors M1 to M5 and the capacitors C_{FLY1} and C_{MID1} constitutes the switched capacitor circuit. The control circuit 40C allows this circuit to operate as the switched capacitor circuit, so as to generate the intermediate voltage V_{MID1} corresponding to the divided voltage of the input voltage V_{IN}, at the positive terminal of the capacitor C_{MID1}. The intermediate voltage V_{MID1} is substantially equal to the voltage (V_{IN}/2). To be exact, the intermediate voltage V_{MID1} fluctuates a little around the voltage (V_{IN}/2).

The converter CNV2 is noted. In the state ST_C1, magnitudes of the currents 915 and 914 (i.e., magnitudes of the inductor currents I_{L2} and I_{L4}) are approximately the same. In addition, in the state ST_C2, magnitudes of the currents 917 and 914 (i.e., magnitudes of the inductor currents I_{L2} and I_{L4}) are approximately the same. Further, in the state ST_C2, the transistors M6 and M8 are ON, and hence the state ST_C2 for the capacitors C_{FLY2} and C_{MID2} is equivalent to the state where the capacitors C_{FLY2} and C_{MID2} are connected in series. In addition, in the states ST_C3 and ST_C4, the capacitors C_{FLY2} and C_{MID2} are connected in parallel through the transistors M7 and M1. As a result, the circuit including the transistors M5 to M8 and M1 and the capacitors C_{FLY2} and C_{MID2} constitutes the switched capacitor circuit. The control circuit 40C allows this circuit to operate as the switched capacitor circuit, so as to generate the intermediate voltage V_{MID2} corresponding to the divided voltage of the input voltage V_{IN}, at the positive terminal of the capacitor C_{MID2}. The intermediate voltage V_{MID2} is substantially equal to the voltage (V_{IN}/2). To be exact, the intermediate voltage V_{MID2} fluctuates a little around the voltage (V_{IN}/2).

The step-up circuit 50C includes a step-up circuit for the converter CNV1 and a step-up circuit for the converter CNV2.

The step-up circuit for the converter CNV1 is the same as the step-up circuit 50A in the first embodiment (see FIG. 7). Therefore, the transistor Ma in the step-up circuit for the converter CNV1 is OFF during ON period of the transistor M2, while it is ON during OFF period of the transistor M2. The transistor Mb in the step-up circuit for the converter CNV1 is OFF during ON period of the transistor M3, while it is ON during OFF period of the transistor M3. The transistor Mc in the step-up circuit for the converter CNV1 is OFF during ON period of the transistor M4, while it is ON during OFF period of the transistor M4. When noting only the states of the transistors M1 to M4 and Ma to Mc, the state ST_C2 of FIG. 20 is equivalent to the state ST_A1 of FIG. 9, while the state ST_C4 of FIG. 22 is equivalent to the state ST_A2 of FIG. 10.

The step-up circuit for the converter CNV1 generates the boot voltages for turning on the transistors M2 to M4, while the step-up circuit for the converter CNV2 generates the boot voltages for turning on the transistor M6 to M8. Except for this point, the configuration and the operation of the step-up circuit for the converter CNV2 may be the same as the configuration and the operation of the step-up circuit for the converter CNV1.

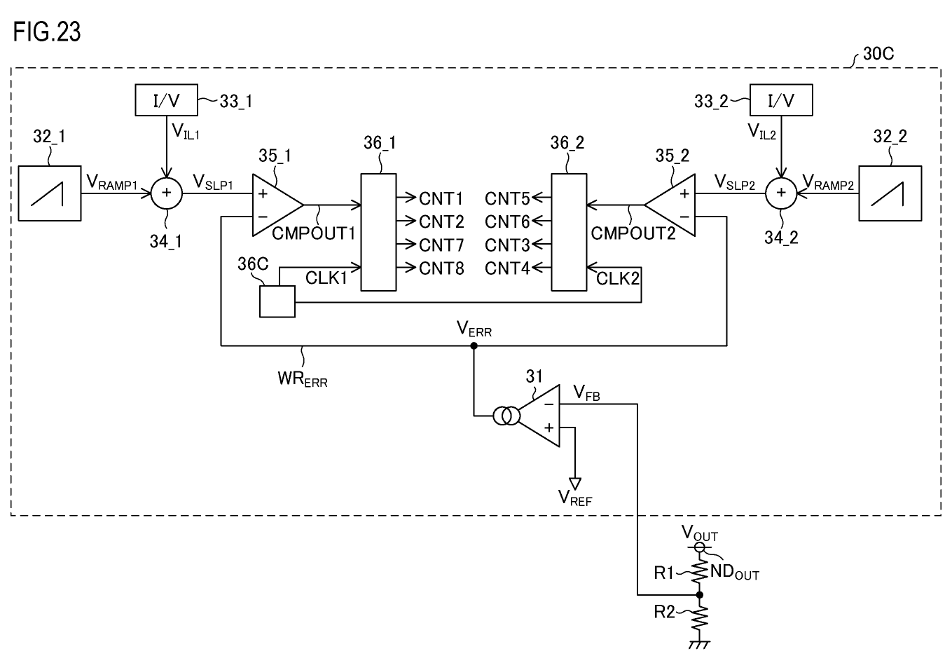

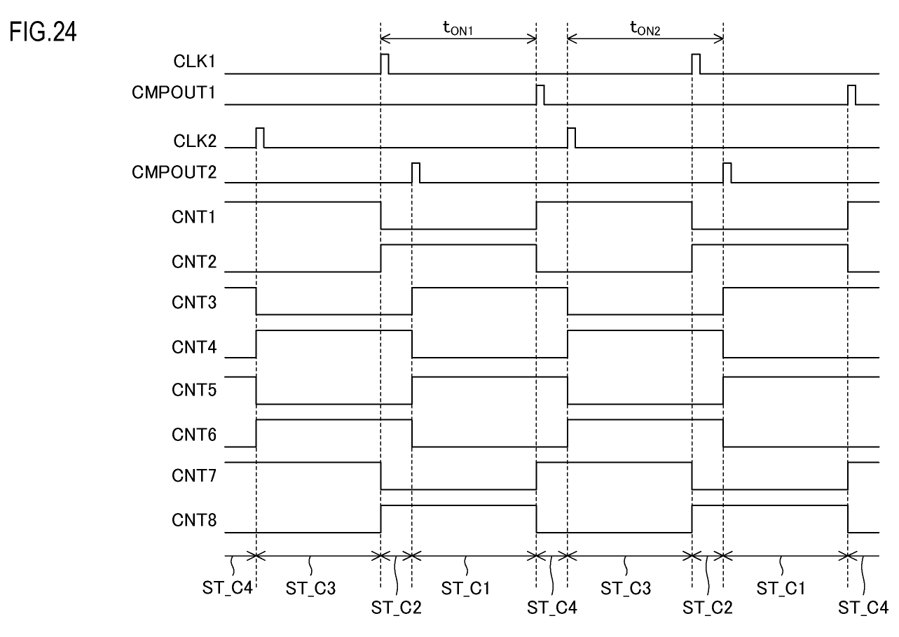

FIG. 23 illustrates an internal configuration of the control circuit 30C. FIG. 24 illustrates a timing chart related to the operation of the control circuit 30C. FIG. 24 illustrates waveforms of the signal CLK1, CMPOUT1, CLK2, CMPOUT2, and CNT1 to CNT8, from top to bottom.

The control circuit 30C includes the error amplifier 31, ramp circuits 32_1 and 32_2, current information acquisition circuits 33_1 and 33_2, adders 34_1 and 34_2, PWM comparators 35_1 and 35_2, a clock generation circuit 36C, and controllers 37_1 and 37_2. Note that the resistors R1 and R2 are disposed in the power supply device 1C. The first terminal of the resistor R1 is connected to the output node ND_{OUT}, the second terminal of the resistor R1 is connected to the first terminal of the resistor R2, and the second terminal of the resistor R2 is connected to the ground. The feedback voltage V_{FB} corresponding to the output voltage V_{OUT} is generated at a connection node between the resistors R1 and R2. The feedback voltage V_{FB} is a divided voltage of the output voltage V_{OUT}, and hence is proportional to the output voltage V_{OUT}. The resistors R1 and R2 constitute the feedback voltage generation circuit that generates the feedback voltage V_{FB}. The feedback voltage V_{FB} is supplied to the control circuit 30C. However, the feedback voltage generation circuit may be understood to be included in components of the control circuit 30C. In addition, the output voltage V_{OUT} itself may be the feedback voltage V_{FB}. In any case, the feedback voltage V_{FB} is the information of the output voltage V_{OUT} (specifically, information indicating a value of the output voltage V _{OUT}).

The error amplifier 31 is a transconductance amplifier of a current output type. The error amplifier 31 has an inverting input terminal, a non-inverting input terminal, and output terminal. The feedback voltage V_{FB} is supplied to the inverting input terminal of the error amplifier 31. The predetermined reference voltage V_{REF} is supplied to the non-inverting input terminal of the error amplifier 31. The reference voltage V_{REF} is a DC voltage having a positive predetermined voltage value, and is generated in a not shown reference voltage generation circuit in the control circuit 30C. The output terminal of the error amplifier 31 is connected to the wiring WR_{ERR}. Note that when the power supply device 1C is activated, a soft start control may be performed in which a value of the reference voltage V_{REF} is gradually increased from 0 V to the positive predetermined voltage value, but in the following description, it is ignored that there is the soft start control.

The error amplifier 31 outputs from its own output terminal a current signal corresponding to the difference between the feedback voltage V_{FB} and the reference voltage V_{REF}, so as to allow the wiring WR_{ERR} to generate the error voltage V_{ERR} corresponding to the difference between the feedback voltage V_{FB} and the reference voltage V_{REF}. Specifically, the error amplifier 31 outputs a current from its own output terminal to the wiring WR_{ERR} so that the error voltage V_{ERR} is increased, if the feedback voltage V_{FB} is lower than the reference voltage V_{REF}, while it pulls in a current from the wiring WR_{ERR} to its own output terminal so that the error voltage V_{ERR} is decreased, if the feedback voltage V_{FB} is higher than the reference voltage V_{REF}. Note that although not particularly illustrated, a phase compensation circuit including a capacitor may be connected between the wiring WR_{ERR} and the ground.

The ramp circuit 32_1 generates a ramp voltage V_{RAMP1}, which simply increases from the predetermined initial voltage V_{INT} with a predetermined change rate, during ON period of the transistor M2. In the ramp circuit 32_1, the initial voltage V_{INT} is 0 V, for example, but it can be different from 0 V. During OFF period of the transistor M2, the ramp voltage V_{RAMP1} is fixed at the initial voltage V_{INT}.

The current information acquisition circuit 33_1 acquires the current information of the inductor L1, and generates the sense voltage V_{IL1} that indicates the current information of the inductor L1. The current information of the inductor L1 is information that indicates a value of the inductor current I_{L1}. The sense voltage V_{IL1} has a voltage value proportional to the value of the inductor current I_{L1} with a positive proportionality coefficient. Therefore, the sense voltage V_{IL1} increases along with an increase in the inductor current I_{L1}, and the sense voltage V _{IL1} decreases along with a decrease in the inductor current I_{L1}. Here, it is supposed that "V_{IL1} = k_{IV} × I_{L1}" holds, where k_{IV} is a predetermined positive coefficient.

As long as the sense voltage V_{IL1} indicates the current information of the inductor L1, the method of generating the sense voltage V_{IL1} is arbitrary. For instance, it may be possible to generate the sense voltage V_{IL1} by directly detecting the inductor current I_{L1} using a current sensor. Here, the current sensor may be a shunt resistor (not shown) inserted between the inductor L1 and the node ND1 in series. Alternatively, for example, it may be possible to generate the sense voltage V_{IL1} by detecting the current flowing in the transistor M2 (i.e., the inductor current I_{L1}) during ON period of the transistor M2, or by detecting the current flowing in the transistor M1 (i.e., the inductor current I_{L1}) during ON period of the transistor M1. Other than that, it may be possible to generate the sense voltage V_{IL1} by detecting the voltage at any point where the voltage corresponding to the inductor current I_{L1} is generated.

The adder 34_1 adds the sense voltage V_{IL1} to the ramp voltage V_{RAMP1}, so as to generate the sum voltage of them as the slope voltage V_{SLP1}. In other words, "V_{SLP1} = V_{RAMP1} + V_{IL1}" holds.

The PWM comparator 35_1 compares the error voltage V_{ERR} with the slope voltage V_{SLP1}, so as to generate and output the signal CMPOUT1 indicating the comparison result. The error voltage V_{ERR} is input to the inverting input terminal of the PWM comparator 35_1, and the slope voltage V_{SLP1} is input to the non-inverting input terminal of the PWM comparator 35_1. The PWM comparator 35_1 outputs the signal CMPOUT1 of low level when "V_{SLP1} < V_{ERR}" holds, and outputs the signal CMPOUT1 of high level when "V_{SLP1} > V_{ERR}" holds. When "V_{SLP1} = V_{ERR}" holds, the signal CMPOUT1 has low level or has high level.

The signal CMPOUT1 and the reference clock signal CLK1 are input to the controller 37_1. The reference clock signal CLK1 is generated in the clock generation circuit 36C. The reference clock signal CLK1 is a square wave signal having the predetermined frequency f_{PWM}, and has a signal level of alternate high level and low level. The duty ratio of the reference clock signal CLK1 is arbitrary. Here, it is supposed that the reference clock signal CLK1 has low level in principle, and has high level for a very short period of time at an interval that is the reciprocal of the frequency f_{PWM} (see FIG. 24).

By a trigger of a predetermined level change in the reference clock signal CLK1, the controller 37_1 allows the control signals CNT1 and CNT7 to generate falling edges so as to turn off the transistors M1 and M7, and allows the control signals CNT2 and CNT8 to generate rising edges so as to turn on the transistors M2 and M8. The predetermined level change in the reference clock signal CLK1 (a first predetermined level change) is a change from low level to high level of the reference clock signal CLK1 here, but it may be a change from high level to low level of the reference clock signal CLK1.

After turning off of the transistors M1 and M7 and turning on of the transistors M2 and M8, the state where "V_{SLP1} < V_{ERR}" holds is changed to the state where "V_{SLP1} > V_{ERR}" holds via a simple increase in the slope voltage V_{SLP1}, and hence the signal CMPOUT1 generates a rising edge. After the signal CMPOUT1 generates a rising edge, the controller 37_1 allows the control signals CNT1 and CNT7 to generate rising edges so as to turn on the transistors M1 and M7, and allows the control signals CNT2 and CNT8 to generate falling edges so as to turn off the transistors M2 and M8. Along with turning off of the transistor M2, the ramp voltage V_{RAMP1} is decreased to be the sufficiently low initial voltage V_{INT}, so that the state where "V_{SLP1} < V_{ERR}" holds is restored, and hence the signal CMPOUT1 promptly generates a falling edge. Note that the period of time after the transistors M1 and M7 are turned off while the transistors M2 and M8 are turned on, until the transistors M1 and M7 are turned on while the transistors M2 and M8 are turned off, is referred to as a time t_{ON1}.

The ramp circuit 32_2 generates a ramp voltage V_{RAMP2}, which simply increases from the predetermined initial voltage V_{INT} with a redetermined change rate during ON period of the transistor M6. In the ramp circuit 32_2, the initial voltage V_{INT} is 0 V for example, but it can be different from 0 V. During OFF period of the transistor M6, the ramp voltage V_{RAMP2} is fixed to the initial voltage V_{INT}. Note that the ramp circuit 32_2 has the same configuration as the ramp circuit 32_1. For this reason, the change rate of the ramp voltage V_{RAMP2} during ON period of the transistor M6 is equal to the change rate of the ramp voltage V_{RAMP1} during ON period of the transistor M2.

The current information acquisition circuit 33_2 acquires the current information of the inductor L2, and generates a sense voltage V_{IL2} indicating the current information of the inductor L2. The current information of the inductor L2 is information indicating a value of the inductor current I_{L2}. The sense voltage V_{IL2} has a voltage value proportional to the value of the inductor current I_{L2} with a positive proportionality coefficient. Therefore, the sense voltage V_{IL2} is increased along with an increase in the inductor current I_{L2}, while the sense voltage V_{IL2} is decreased along with a decrease in the inductor current I_{L2}. Here, it is supposed that "V_{IL2} = k_{IV} × I_{L2}" holds.

As long as the sense voltage V_{IL2} indicates the current information of the inductor L2, the method of generating the sense voltage V _{IL2} is arbitrary. For instance, it may be possible to generate the sense voltage V_{IL2} by directly detecting the inductor current I_{L2} using a current sensor. Here, the current sensor may be a shunt resistor (not shown) inserted between the inductor L2 and the node ND5 in series. Alternatively, for example, it may be possible to generate the sense voltage V_{IL2} by detecting the current flowing in the transistor M6 (i.e., the inductor current I_{L2}) during ON period of the transistor M6, or by detecting the current flowing in the transistor M5 (i.e., the inductor current I_{L2}) during ON period of the transistor M5. Other than that, it may be possible to generate the sense voltage V_{IL2} by detecting the voltage at any point where the voltage corresponding to the inductor current I_{L2} is generated.

The adder 34_2 adds the sense voltage V_{IL2} to the ramp voltage V_{RAMP2}, so as to generate the sum voltage of them as a slope voltage V_{SLP2}. In other words, "V_{SLP2} = V_{RAMP2} + V_{IL2}" holds.

The PWM comparator 35_2 compares the error voltage V_{ERR} with the slope voltage V_{SLP2}, and generates and outputs the signal CMPOUT2 indicating the comparison result. The error voltage V_{ERR} is input to the inverting input terminal of the PWM comparator 35_2, and the slope voltage V_{SLP2} is input to the non-inverting input terminal of the PWM comparator 35_2. The PWM comparator 35_2 outputs the signal CMPOUT2 of low level when "V_{SLP2} < V_{ERR}" holds, while it outputs the signal CMPOUT2 of high level when "V_{SLP2} > V_{ERR}" holds. The signal CMPOUT2 has low level or high level when "V_{SLP2} = V_{ERR}" holds.

The signal CMPOUT2 and the shift clock signal CLK2 are input to the controller 37_2. The shift clock signal CLK2 is generated by the clock generation circuit 36C on the basis of the reference clock CLK1. The shift clock signal CLK2 is a signal obtained by shifting the phase of the reference clock CLK1. Therefore, the reference clock signal CLK1 and the shift clock signal CLK2 have the same frequency f_{PWM} and different phases. Similarly to the reference clock CLK1, the shift clock signal CLK2 has low level in principle, and has high level for a very short period of time at an interval that is the reciprocal of the frequency f_{PWM} (see FIG. 24). Here, it is supposed that the shift clock signal CLK2 is a signal having the phase delayed from the reference clock signal CLK1 by 180 degrees. Therefore, the phase difference between the clock signals CLK1 and CLK2 is 180 degrees. To set the delay amount to 180 degrees is optimal for minimizing a ripple of the output voltage V_{OUT}. However, the phase delay amount of the shift clock signal CLK2 from the reference clock signal CLK1 may be other than 180 degrees (may be 170 degrees or 190 degrees, for example).

By a trigger of a predetermined level change in the shift clock signal CLK2, the controller 37_2 allows the control signals CNT3 and CNT5 to generate falling edges so as to turn off the transistors M3 and M5, and allows the control signals CNT4 and CNT6 to generate rising edges so as to turn on the transistors M4 and M6. The predetermined level change in the shift clock signal CLK2 (a second predetermined level change) is a change from low level to high level of the shift clock signal CLK2 here, but it may be a change from high level to low level of the shift clock signal CLK2.

After turning off of the transistors M3 and M5 and turning on of the transistors M4 and M6, the state where "V_{SLP2} < V_{ERR}" holds is changed to the state where "V_{SLP2} > V_{ERR}" holds via a simple increase in the slope voltage V_{SLP2}, and hence the signal CMPOUT2 generates a rising edge. When the signal CMPOUT2 generates a rising edge, the controller 37_2 allows the control signals CNT3 and CNT5 to generate rising edges so as to turn on the transistors M3 and M5, and allows the control signals CNT4 and CNT6 to generate falling edges so as to turn off the transistors M4 and M6. Along with turning off of the transistor M6, the ramp voltage V_{RAMP2} is decreased to be the sufficiently low initial voltage V_{INT}, so that the state where "V_{SLP2} < V_{ERR}" holds is restored, and hence the signal CMPOUT2 promptly generates a falling edge. Note that the period of time after the transistors M3 and M5 are turned off while the transistors M4 and M6 are turned on, until the transistors M3 and M5 are turned on while the transistors M4 and M6 are turned off, is referred to as a time t_{ON2}.

By the above switching control performed by the controllers 37_1 and 37_2, as illustrated in FIG. 24 (also see FIGS. 19 to 22), the states of the transistors M1 to M8 are sequentially changed among the states ST_C1 to ST_C4. In other words, in the timing chart of FIG. 24, from the state ST_C3 as a start point, the states of the transistors M1 to M8 are changed from the state ST_C3 to the state ST_C2 by a trigger of a rising edge of the reference clock signal CLK1, and then the state ST_C2 is changed to the state ST_C1 by a trigger of a rising edge of the signal CMPOUT2, and then the state ST_C1 is changed to the state ST_C4 by a trigger of a rising edge of the signal CMPOUT1, and then the state ST_C4 is changed back to the state ST_C3 by a trigger of a rising edge of the shift clock signal CLK2. After that, the same operation is repeated. The length of period, between change timing from the state ST_C3 to the state ST_C2 and the next change timing from the state ST_C3 to the state ST_C2, is equal to the reciprocal of the frequency f_{PWM} of the reference clock signal CLK1.

When "V_{OUT} = V_{TG}" holds, "V_{FB} = V_{REF}" holds. When the load current I_{LD} is increased from the state where "V_{OUT} = V_{TG}" holds as a start point so that "V_{OUT} < V_{TG}" holds, "V_{FB} < V_{REF}" holds and hence the error voltage V_{ERR} is increased. The increase in the error voltage V_{ERR} causes an increase in the ON period of the transistors M2 and M6. The increase in the ON period of the transistor M2 causes an increase in the inductor current I_{L1}, and the increase in the ON period of the transistor M6 causes an increase in the inductor current I_{L2}. As a result, the output voltage V_{OUT} is increased toward the target voltage V_{TG}. On the contrary, when the load current I_{LD} is decreased from the state where "V_{OUT} = V_{TG}" holds as a start point so that "V_{OUT} > V_{TG}" holds, "V_{FB} > V_{REF}" holds and hence the error voltage V_{ERR} is decreased. The decrease in the error voltage V_{ERR} causes a decrease in the ON period of the transistors M2 and M6. The decrease in the ON period of the transistor M2 causes a decrease in the inductor current I_{L1}, and the decrease in the ON period of the transistor M6 causes a decrease in the inductor current I_{L2}. As a result, the output voltage V_{OUT} is decreased toward the target voltage V_{TG}. In this way, the control of decreasing the difference between the output voltage V_{OUT} and the target voltage V_{TG} is performed.

The time t_{ON1} described above depends on the error voltage V_{ERR} (i.e., depends on the information of the output voltage V_{OUT}), and depends on the sense voltage V_{IL1} (i.e., depends on the current information of the inductor L1). In other words, the controller 37_1 performs switching control of the transistors M1, M2, M7 and M8 in synchronization with the reference clock signal CLK1, on the basis of the information of the output voltage V_{OUT} and the current information of the inductor L1. The controller 37_1 turns off the transistors M1 and M7, and turns on the transistors M2 and M8, by a trigger of a predetermined level change in the reference clock signal CLK1, and then turns on the transistors M1 and M7, and turns off the transistors M2 and M8, after the time t_{ON1} elapses corresponding to the information of the output voltage V_{OUT} and the current information of the inductor L1.

The time t_{ON2} described above depends on the error voltage V_{ERR} (i.e., depends on the information of the output voltage V_{OUT}), and depends on the sense voltage V_{IL2} (i.e., depends on the current information of the inductor L2). In other words, the controller 37_2 performs switching control of the transistors M3 to M6 in synchronization with the shift clock signal CLK2, on the basis of the information of the output voltage V_{OUT} and the current information of the inductor L2. The controller 37_2 turns off the transistors M3 and M5, and turns on the transistors M4 and M6, by a trigger of a predetermined level change in the shift clock signal CLK2, and then turns on the transistors M3 and M5, and turns off the transistors M4 and M6, after the time t_{ON2} elapses corresponding to the information of the output voltage V _{OUT} and the current information of the inductor L2.

The converters CNV1 and CNV2 have the same configuration. In addition, the switching control of the transistors M1, M2, M7 and M8 based on the current information of the inductor L1, and the switching control of the transistors M3, M4, M5 and M6 based on the current information of the inductor L2, are equivalent to each other. Therefore, a multiphase operation can be realized in a balanced state between the output current of the converter CNV1 and the output current of the converter CNV2.

In the power supply device 1C, the output current of the converter CNV1 is the sum of the inductor currents I_{L1} and I_{L3}, and the output current of the converter CNV2 is the sum of the inductor currents I_{L2} and I_{L4}. The average of the output current of the first channel buck converter (i.e., the inductor current I_{L1}) and the average of the output current of the first channel stacked converter (i.e., the inductor current I_{L3}) are substantially the same. Similarly, the average of the output current of the second channel buck converter (i.e., the inductor current I_{L2}) and the average of the output current of the second channel stacked converter (i.e., the inductor current I_{L4}) are substantially the same. As a result, although instantaneous values of the inductor currents I_{L1} to I_{L4} are different from each other at each timing, the average of the inductor current I_{L1}, the average of the inductor current I_{L2}, the average of the inductor current I_{L3}, and the average of the inductor current I_{L4} are substantially equal to each other.

The output current of the first channel buck converter (i.e., the inductor current I_{L1}), the output current of the second channel buck converter (i.e., the inductor current I_{L2}), the output current of the first channel stacked converter (i.e., the inductor current I_{L3}), and the output current of the second channel stacked converter (i.e., the inductor current I_{L4}) are each an pulsating current. Among them, the output current of the first channel buck converter (i.e., the inductor current I_{L1}) and the output current of the first channel stacked converter (i.e., the inductor current I_{L3}) have different phases, while the output current of the second channel buck converter (i.e., the inductor current I_{L2}) and the output current of the second channel stacked converter (i.e., the inductor current I_{L4}) have different phases.

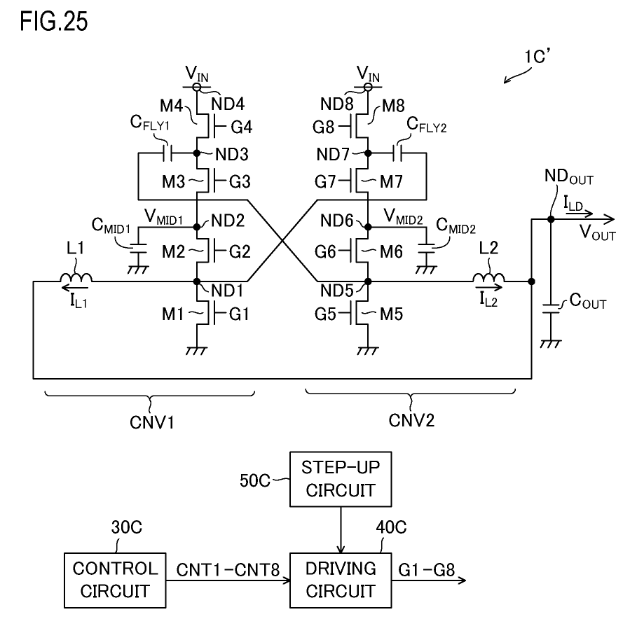

Note that it may be possible to eliminate the inductors L3 and L4 from the power supply device 1C of FIG. 18, so as to deform the power supply device 1C into a power supply device 1C' of FIG. 25. The power supply device 1C' is different from the power supply device 1C in that the current passing through the inductors L3 and L4 is not generated, and in other points, the configuration and the operation of the power supply device 1C' are the same as those of the power supply device 1C.

In addition, although not particularly illustrated, in the power supply device 1C or 1C', the capacitor C_{MID2} may be eliminated, and in this case, the nodes ND2 and ND6 are short-circuited. Alternatively, in the power supply device 1C or 1C', it may be possible to eliminate the capacitor C_{MID2}, and to insert the capacitor C_{MID1} between the nodes ND2 and ND6 (i.e., it may be possible to connect the first terminal of the capacitor C_{MID1} to the node ND2, and to connect the second terminal of the capacitor C_{MID1} to the node ND6).

### Fourth Embodiment

A fourth embodiment of the present disclosure is described below. In the fourth embodiment, variation technique, application technique, supplementary note, and the like for the first to third embodiments are described.

The power supply device according to the present disclosure is referred to as a power supply device 1. The power supply device 1 may be any one of the power supply devices described in the first to third embodiments, and hence may be any one of the power supply devices 1A, 1B, 1C and 1C'. The power supply device 1 can be applied to any device or system that requires a stable DC voltage. For instance, the power supply device 1 may be applied to a power supply system for a data center. In this case, for example, the output voltage V_{OUT} of the power supply device 1 may be 48 V, so that the power supply device 1 supplies the output voltage V_{OUT} to a power supply bus of 48 V. In recent years, it is an important issue to reduce power consumption in the data center, and in this situation, replacements of power supply buses of 12 V with power supply buses of 48 V are proceeding. It is necessary to supply electric power from a power supply bus of 48 V to a server system, or to a storage device including a semiconductor memory, a magnetic disk, or the like, with high efficiency. Using the power supply device 1, it is possible to supply electric power with high efficiency.

Alternatively, the power supply device 1 may be applied to a primary power supply in a vehicle such as an automobile. In this case, the power supply device 1 may directly receive the input voltage V_{IN} from a battery mounted in the vehicle so as to generate the output voltage V_{OUT}, and the output voltage V_{OUT} may function as a voltage for driving any system (e.g., an automated driving system of level 3 or higher) mounted in the vehicle. Alternatively, for example, the power supply device 1 may be applied to a power supply for a charging system. The charging system may be a system for charging a battery of an electric vehicle. Alternatively, for example, the power supply device 1 may be applied to a power supply for a base station.

For any signal or voltage, the relationship between high level and low level can be opposite to that described above, in a form where the spirit of the above description is not deteriorated.

The channel type of the FET (field-effect transistor) described in each embodiment is merely an example. The channel type of any FET can be changed between a P-channel type and an N-channel type, in a form where the spirit of the above description is not deteriorated.

As long as no inconvenience is caused, any transistor described above may be a transistor of any type. For instance, any transistor described above as a MOSFET can be replaced with a junction type FET, an IGBT (Insulated Gate Bipolar Transistor), or a bipolar transistor, as long as no inconvenience is caused. Any transistor has a first electrode, a second electrode, and a control electrode. In an FET, one of the first and the second electrodes is the drain, while the other is the source, and the control electrode is the gate. In an IGBT, one of the first and the second electrodes is the collector, while the other is the emitter, and the control electrode is the gate. In a bipolar transistor that is not classified as an IGBT, one of the first and the second electrodes is the collector, while the other is the emitter, and the control electrode is the base.

The embodiment of the present disclosure can be appropriately and variously modified within the scope of the technical concept recited in the claims. The embodiments described above are merely examples of the embodiments of the present disclosure, and meanings of terms in the present disclosure or of individual elements are not limited to those described in the above embodiments. Specific numeric vales shown in the above description are merely examples, and can be changed to various values as a matter of course.

### Additional Remarks

Additional remarks are given below for the present disclosure with the above embodiments in which specific configuration examples are shown.

A power supply device according to one aspect of the present disclosure (e.g., 1A; see FIGS. 1 and 6 to 8) includes a first switching element (M1) disposed between a first node (ND1) and a reference node having a potential lower than an input voltage (V_{IN}); a second switching element (M2) disposed between the first node and a second node (ND2); a third switching element (M3) disposed between the second node and a third node (ND3); a fourth switching element (M4) disposed between the third node and a fourth node (ND4) receiving the input voltage; a step-up circuit (50A) configured to generate a first boot voltage (V_{BOOT1}) in a first boot wiring (W_{BOOT1}), the first boot voltage being supplied to the gate of the second switching element so as to turn on the second switching element, and to generate a second boot voltage (V _{BOOT2}) in a second boot wiring (W_{BOOT2}), the second boot voltage being supplied to the gate of the third switching element so as to turn on the third switching element, and to generate a third boot voltage (V_{BOOT3}) in a third boot wiring (W_{BOOT3}), the third boot voltage being supplied to the gate of the fourth switching element so as to turn on the fourth switching element; a control circuit (30A) configured to generate a control signal for designating a state of each switching element; and a driving circuit (40A) configured to individually turn on or off the first to the fourth switching elements in accordance with the control signal, using a predetermined drive voltage (V_{DRV}) and the first to the third boot voltages, in which when the states of the first to the fourth switching elements are controlled, an output voltage (V_{OUT}) lower than the input voltage is generated, the first to the fourth switching elements are each constituted of an N-channel type field-effect transistor, the step-up circuit includes a first boot capacitor (C_{BOOT1}) disposed between the first node and the first boot wiring, a second boot capacitor (C_{BOOT2}) disposed between the second node and the second boot wiring, a third boot capacitor (C_{BOOT3}) disposed between the third node and the third boot wiring, a first boot switch (Ma) disposed between the first boot wiring and a drive wiring (W_{DRV}) applied with the drive voltage, a second boot switch (Mb) disposed between the first boot wiring and the second boot wiring, and a third boot switch (Mc) disposed between the second boot wiring and the third boot wiring, and when the control circuit controls the states of the switching elements and the boot switches, the first to the third boot voltages are generated (first configuration).

In this way, it is possible to form a high-efficiency power supply device in which switching loss of each switching element is suppressed to be low.

In the power supply device according to the above first configuration (see FIGS. 9 and 10), it may be possible to adopt a configuration (second configuration), in which the control circuit switches the states of the first to the fourth switching elements among a plurality of states including a first state (ST_A1) and a second state (ST_A2), the second switching element and the fourth switching element are ON while the first switching element and the third switching element are OFF in the first state, and the second switching element and the fourth switching element are OFF while the first switching element and the third switching element are ON in the second state.

In the power supply device according to the above second configuration (see FIGS. 9 and 10), it may be possible to adopt a configuration (third configuration), in which the step-up circuit sets the first boot switch and the third boot switch to be OFF while sets the second boot switch to be ON in the first state, and sets the first boot switch and the third boot switch to be ON while sets the second boot switch to be OFF in the second state.

In the power supply device according to any one of the above first to third configurations, it may be possible to adopt a configuration (fourth configuration), in which the first to the third boot switches are each constituted of a P-channel type field-effect transistor.

By constituting each boot switch of a P-channel type field-effect transistor, a high boot voltage can be obtained. As a result, switching loss of each switching element can be suppressed to be low. In addition, when constituting a power supply device using a semiconductor device having a semiconductor integrated circuit and a group of discrete components, a control circuit and the like can be disposed in the semiconductor integrated circuit, and in this case, it is easy to dispose also the boot switches in the semiconductor integrated circuit. For this reason, the number of components can be reduced in the power supply device, and hence it is also possible to downsize the power supply device.

In the power supply device according to the above fourth configuration (see FIGS. 9 and 10), it may be possible to adopt a configuration (fifth configuration), in which the step-up circuit sets the first boot switch to be ON or OFF on the basis of a voltage (V_{LX}) at the first node and the first boot voltage, sets the second boot switch to be ON or OFF on the basis of a voltage (V_{MID}) at the second node and the second boot voltage, and sets the third boot switch to be ON or OFF on the basis of a voltage (V_{FLY}) at the third node and the third boot voltage.

In the power supply device according to any one of the above first to fifth configurations, it may be possible to adopt a configuration (sixth configuration), in which the control circuit performs switching control for switching the states of the first to the fourth switching elements among the plurality of states, on the basis of information of the output voltage and current information of an inductor (L1) disposed between the first node and an output node applied with the output voltage, so as to divide the input voltage and to step down an intermediate voltage (V_{MID}) obtained by the division, thereby generates the output voltage, and in the switching control, the control circuit allows a circuit including the first to the fourth switching elements, an intermediate capacitor (C_{MID}) connected to the second node, and a flying capacitor (C_{FLY}) connected to the third node, to operate as the switched capacitor circuit so as to generate the intermediate voltage at the second node.

In the power supply device according to any one of the above first to sixth configurations, it may be possible to adopt a configuration (seventh configuration), in which the control signal generated by the control circuit includes first to fourth control signals (CNT1 to CNT4), and the driving circuit includes a first gate driver (42_1) configured to drive the gate of the first switching element in accordance with the first control signal, on the basis of the drive voltage and a voltage at the reference node (VSS), so as to turn on or off the first switching element; a second gate driver (42_2) configured to drive the gate of the second switching element in accordance with the second control signal, on the basis of the first boot voltage and a voltage (V _{LX}) at the first node, so as to turn on or off the second switching element; a third gate driver (42_3) configured to drive the gate of the third switching element in accordance with the third control signal, on the basis of the second boot voltage and a voltage (V_{MID}) at the second node, so as to turn on or off the third switching element; and a fourth gate driver (42_4) configured to drive the gate of the fourth switching element in accordance with the fourth control signal, on the basis of the third boot voltage and a voltage (V_{FLY}) at the third node, so as to turn on or off the fourth switching element.

Claims:

1. : A power supply device comprising:
a first switching element disposed between a first node and a reference node having a potential lower than an input voltage;
a second switching element disposed between the first node and a second node;
a third switching element disposed between the second node and a third node;
a fourth switching element disposed between the third node and a fourth node receiving the input voltage;
a step-up circuit configured to generate a first boot voltage in a first boot wiring, the first boot voltage being supplied to a gate of the second switching element so as to turn on the second switching element, and to generate a second boot voltage in a second boot wiring, the second boot voltage being supplied to a gate of the third switching element so as to turn on the third switching element, and to generate a third boot voltage in a third boot wiring, the third boot voltage being supplied to a gate of the fourth switching element so as to turn on the fourth switching element;
a control circuit configured to generate a control signal for designating a state of each switching element; and
a driving circuit configured to individually turn on or off the first to the fourth switching elements in accordance with the control signal, using a predetermined drive voltage and the first to the third boot voltages, wherein
when the states of the first to the fourth switching elements are controlled, an output voltage lower than the input voltage is generated,
the first to the fourth switching elements are each constituted of an N-channel type field-effect transistor,
the step-up circuit includes
a first boot capacitor disposed between the first node and the first boot wiring,
a second boot capacitor disposed between the second node and the second boot wiring,
a third boot capacitor disposed between the third node and the third boot wiring,
a first boot switch disposed between the first boot wiring and a drive wiring applied with the drive voltage,
a second boot switch disposed between the first boot wiring and the second boot wiring, and
a third boot switch disposed between the second boot wiring and the third boot wiring, and
when the control circuit controls the states of the switching elements and the boot switches, the first to the third boot voltages are generated.

2. : The power supply device according to claim 1, wherein
the control circuit switches the states of the first to the fourth switching elements among a plurality of states including a first state and a second state,
the second switching element and the fourth switching element are ON while the first switching element and the third switching element are OFF in the first state, and
the second switching element and the fourth switching element are OFF while the first switching element and the third switching element are ON in the second state.

3. : The power supply device according to claim 2, wherein the step-up circuit sets the first boot switch and the third boot switch to be OFF while sets the second boot switch to be ON in the first state, and sets the first boot switch and the third boot switch to be ON while sets the second boot switch to be OFF in the second state.

4. : The power supply device according to claim 1, wherein the first to the third boot switches are each constituted of a P-channel type field-effect transistor.

5. : The power supply device according to claim 4, wherein the step-up circuit sets the first boot switch to be ON or OFF on the basis of a voltage at the first node and the first boot voltage, sets the second boot switch to be ON or OFF on the basis of a voltage at the second node and the second boot voltage, and sets the third boot switch to be ON or OFF on the basis of a voltage at the third node and the third boot voltage.

6. : The power supply device according to claim 1, wherein
the control circuit performs switching control for switching the states of the first to the fourth switching elements among a plurality of states, on the basis of information of the output voltage and current information of an inductor disposed between the first node and an output node applied with the output voltage, so as to divide the input voltage and to step down an intermediate voltage obtained by the division, thereby generates the output voltage, and
in the switching control, the control circuit allows a circuit including the first to the fourth switching elements, an intermediate capacitor connected to the second node, and a flying capacitor connected to the third node, to operate as the switched capacitor circuit so as to generate the intermediate voltage at the second node.

7. : The power supply device according to claim 1, wherein
the control signal generated by the control circuit includes first to fourth control signals, and
the driving circuit includes
a first gate driver configured to drive a gate of the first switching element in accordance with the first control signal, on the basis of the drive voltage and a voltage at the reference node, so as to turn on or off the first switching element,
a second gate driver configured to drive the gate of the second switching element in accordance with the second control signal, on the basis of the first boot voltage and a voltage at the first node, so as to turn on or off the second switching element,
a third gate driver configured to drive the gate of the third switching element in accordance with the third control signal, on the basis of the second boot voltage and a voltage at the second node, so as to turn on or off the third switching element, and
a fourth gate driver configured to drive the gate of the fourth switching element in accordance with the fourth control signal, on the basis of the third boot voltage and a voltage at the third node, so as to turn on or off the fourth switching element.
